(19) United States
(12) Patent Application Publication
(10) Pub. No.: US 2019/0182371 A1
(43) Pub. Date: Jun. 13, 2019

(54) SMARTPHONE ACCESSORY FOR VISUALLY IMPAIRED OR ELDERLY USERS

(71) Applicant: ZONE V LTD, Cambridge (GB)

(72) Inventors: Peter ASHALL, Cambridge (GB); Frank NUOVO, Cambridge (GB); George HINES, Cambridge (GB); Richard ASHALL, Cambridge (GB); Sarah GUGGENHEIM, Cambridge (GB)

(21) Appl. No.: 16/322,618

(22) PCT Filed: Aug. 1, 2017
(86) PCT No.: PCT/GB2017/052239

§ 371 Date: Feb. 1, 2019

(30) Foreign Application Priority Data
Aug. 1, 2016 (GB) 1613237.5
Apr. 26, 2017 (GB) 1706654.9

(51) Int. Cl. H04M 1/247; H04M 1/725; G06F 3/0484; G06F 3/0485; G06F 3/0488; G06F 3/16; G06F 3/0482; G06F 3/01; G06F 8/61

(52) U.S. Cl. CPC H04M 1/2474; H04M 1/72527; H04M 1/72583; H04M 1/72594; G06F 3/04845; G06F 3/04817; G06F 3/04883; G06F 3/167; G06F 3/0482; G06F 3/016; G06F 8/61; G06F 3/0485

(57) ABSTRACT

A portable electronic device system provides features to assist a visually impaired or elderly end-user. The system includes a protective case for the portable electronic device, which facilitates the handling and usability of the device for visually impaired or elderly end-users. The case includes a replaceable extension unit, enabling many different sorts of extension unit accessories to be swapped in and out. The system includes a software application executable on the portable electronic device, which enables the device to switch to another and simpler user interface which also enables control of the features or functions provided by the specific extension unit that has been fitted.

### BACKGROUND OF THE INVENTION

### 1. Field of the Invention

The field of the invention relates to an accessory for a smartphone, or other type of portable electronic device, and which provides features to assist a visually impaired or elderly end-user. The system may also appeal to general users with good vision who prefer a simple to use device, or for whom the features offered by the accessory are especially useful.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### 2. Description of the Prior Art

Portable electronic devices, such as smartphones and tablets, are in widespread use, but the dominant, typical form factor, a sheet of touch-screen glass in a thin casing, can be challenging for blind or low-vision users to operate confidently and with assurance. In addition, existing graphical user interfaces for the most popular smartphones and tablets are not fully adapted for visually impaired or elderly end-users; they may include some features, such as text magnification, but that is far from a UI that is fully and completely adapted for the needs of the visually impaired or elderly. Nevertheless, smartphones and tablets designed for mainstream use are also popular with blind and low-vision end-users because of the high-quality of manufacturing and materials, leading to an engaging tactile experience, and the large number of third party apps available.

There are some smartphones that are specifically designed for the elderly. These can have a UI that is highly simplified. But because these smartphones are designed for a relatively small customer group, and are not designed for the mass-market mainstream, they tend not to include the latest hardware and are hence quite low specification devices that are several generations behind the latest mass-market devices.

There is great scope for improving the user experience for visually impaired or elderly users who want a more simplified smartphone or tablet experience, but based on the latest generation, high specification smartphone or tablet.

The present invention addresses the above vulnerabilities and also other problems not described above.

### SUMMARY OF THE INVENTION

One aspect of the invention is an accessory system for a smartphone or tablet or other wireless device, the system comprising:
(a) a case that slides or clips or otherwise attaches to the device, the case enabling one or more features or functions of the device to be enhanced, altered, replaced or varied to include features or functions of specific utility for visually impaired or elderly users; and
(b) software that when installed on the device automatically enhances, alters, replaces or varies pre-installed software on the device to include features or functions of specific utility for visually impaired or elderly users.

The case may come in two parts, namely (a) a base that the user slides or clips or otherwise attaches onto the device, and (b) an accessory or extension module that the user also slides or clips or otherwise attaches onto the device and that provide features or functions that are specific to the needs of the visually impaired or elderly. Different accessory or extension modules can be slid or clipped or otherwise attached on to the device to provide the different functions or features.

The invention is implemented in a system called the Zone V system. The Zone V system is in essence an accessory case that slides onto a fully featured, latest generation smartphone or tablet, combined with software that can be readily downloaded and installed onto the smartphone that alters the entire UI of that smartphone in a way that is simplified and optimised for visually impaired or elderly users. The case itself comes in two parts—a base that the user slides or clips on to the smartphone, and a removable accessory or extension module that also slides or clips on to the smartphone and that provide features that are specific to the needs of the visually impaired or elderly. Different accessory modules can be slid or clipped on to the smartphone (such as a large grab handle; or an enhanced speaker, or physical buttons programmed to call specific people). The software then provides not only a simplified environment, but also then enables control of the features or functions provided by the specific extension unit that has been fitted.

This approach enables the visually impaired or elderly user to have all the benefits of a latest generation smartphone, (ie the most current hardware specifications, such as display screen, operating system, wireless connectivity), and which is readily available through all conventional distribution channels, and yet to have it fully customisable at low cost for their specific needs as a visually impaired or elderly user.

### BRIEF DESCRIPTION OF THE FIGURES

Aspects of the invention will now be described, by way of example, with reference to the following Figures, which each show features of the invention, implemented in the Zone V system.

FIG. 1 shows examples of key features of the Zone V software and protective case.

FIG. 2 shows different views of a Zone V protective case.

FIG. 3 shows a front view of a case when assembled on a smartphone.

FIG. 4 shows a back view of a case when assembled on a smartphone.

FIG. 5 shows a release button mechanism that is positioned on the back of a protective case.

FIG. 6 shows an example of the protective case with a detachable hand grip.

FIG. 7 shows further examples of accessories that may be detachable from a protective case.

FIG. 8 shows the steps for assembly of a case on a smartphone.

FIG. 9 shows a diagram with a protective case to be assembled on a smartphone with a USB cable and a headset jack connector.

FIG. 10 shows the case including openings for a USB socket and for a headphone jack socket.

FIG. 11 shows the case and a USB cable configured to match the opening of the case adjacent to the USB socket.

FIG. 12 shows a case and a headset jack adapter that is configured to match the opening of the case adjacent to the headset jack socket.

FIG. 13 shows diagrams with different views of a USB cable.

FIG. 14 shows diagrams with different views of a headset jack connector.

FIG. 15 shows diagrams with another example of a protective case assembled on a smartphone.

FIG. 16 shows diagrams with another example of a protective case assembled on a smartphone.

FIG. 17 shows diagrams with different views of a USB cable connector.

FIG. 18 shows a diagram illustrating different elements of an additional lens positioned on a protective case.

FIG. 19 shows a protective case for a smartphone comprising an additional lens that can be moved into position over a camera lens integrated into the smartphone.

FIG. 20 shows a workflow diagram illustrating the steps to load a Zone V graphical user interface after booting up the device.

FIG. 21 shows a widget of the software application as seen on a factory installed graphical user interface.

FIG. 22 shows a home screen of a simplified graphical user interface that is split into zones.

FIG. 23 shows a home screen of a simplified graphical user interface that is split into zones.

FIG. 24 shows a screenshot of the graphical user interface when the Magnifier mode is selected which enables a magnified image to be shown directly on a smartphone.

FIG. 25 shows a screenshot of the graphical user interface when the Calendar mode is selected.

FIG. 26 shows a screenshot of the graphical user interface when the Phone mode is selected.

FIG. 27 shows a screenshot of the graphical user interface when the Messages mode is selected.

FIG. 28 shows a screenshot of the Settings menu split into zones.

FIG. 29 shows a screenshot of the Settings menu split into zones.

FIG. 30 shows a screenshot of the Settings menu split into zones.

FIG. 31 shows a screenshot of the visual profiles available through the Settings menu.

FIG. 32 shows screenshots of different visual profiles.

FIG. 33 shows a screenshot of the keypad.

FIG. 34 shows actions or gestures that may be performed by an end-user to interact with the smartphone.

FIG. 35 shows a diagram illustrating the Zone V installation and registration process using NFC.

FIG. 36 shows a screenshot with a browser displaying terms and conditions.

FIG. 37 shows a screenshot with a browser displaying a checkbox that can be selected in order to agree terms and conditions.

FIG. 38 shows a screenshot with a pop up presented to the user after a completed download.

FIG. 39 shows a screenshot of the Zone V app displaying terms and conditions after a package install.

FIG. 40 shows a screenshot of the Zone V app displaying a registration page.

FIG. 41 shows a screenshot of a portable electronic device scanning the barcode present on an installation guide.

FIG. 42 shows a screenshot of a portable electronic device confirming barcode was read.

FIG. 43 shows a screenshot displaying a code on the Zone V app registration page.

### DETAILED DESCRIPTION

This Detailed Description section describes one implementation of the invention, called the Zone V system.

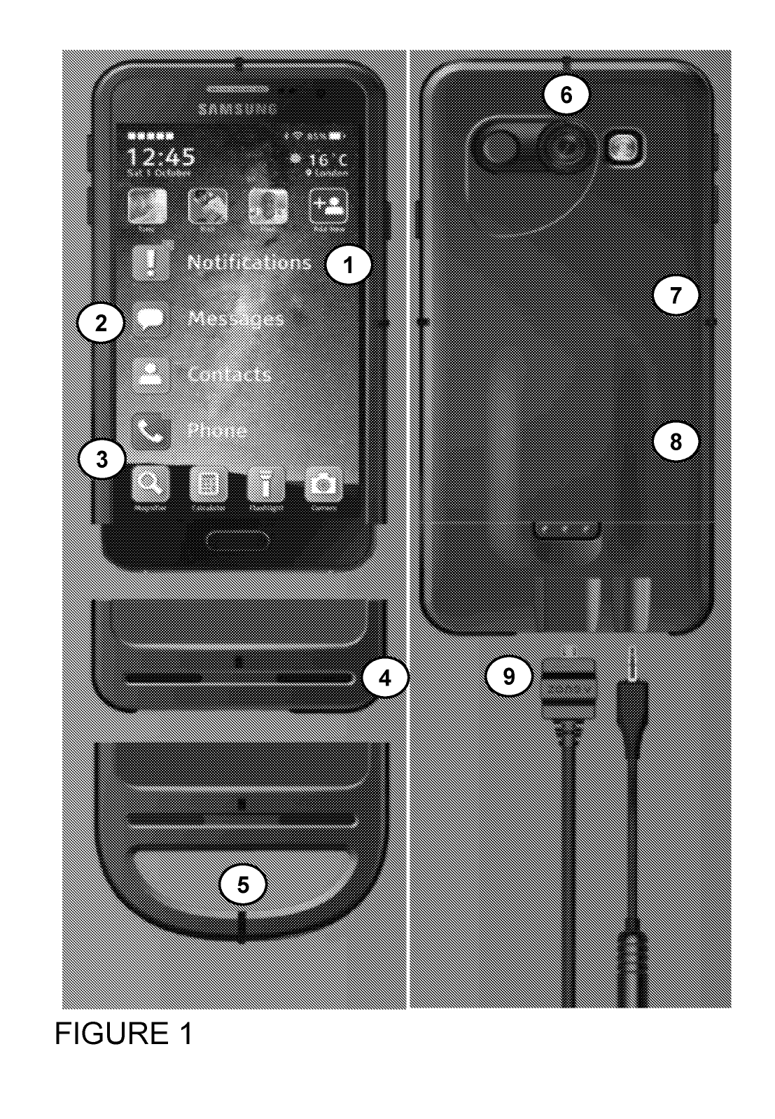

FIG. 1 shows examples of key features of the Zone V software and protective case:
Large text: the unique software makes text easier to read (1);
Alternative menu colours: designed to give optimal contrast and clarity (2);
Clear menu: large and clear icons to improve clarity (3);
Audio Output: front facing clear sound (4);
Hand grip: makes the phone easier to hold (5);
Magnifying lens: slides over camera to form a magnifying lens and provide macro magnifications (6);
Robust case: gives extra protection against drops (7);
Vibration feedback: confirms when icons or keys have been selected (8);
Easy charging: magnets guide the USB charging cable making it easier to connect (9).

### Protective Case of a Portable Electronic Device

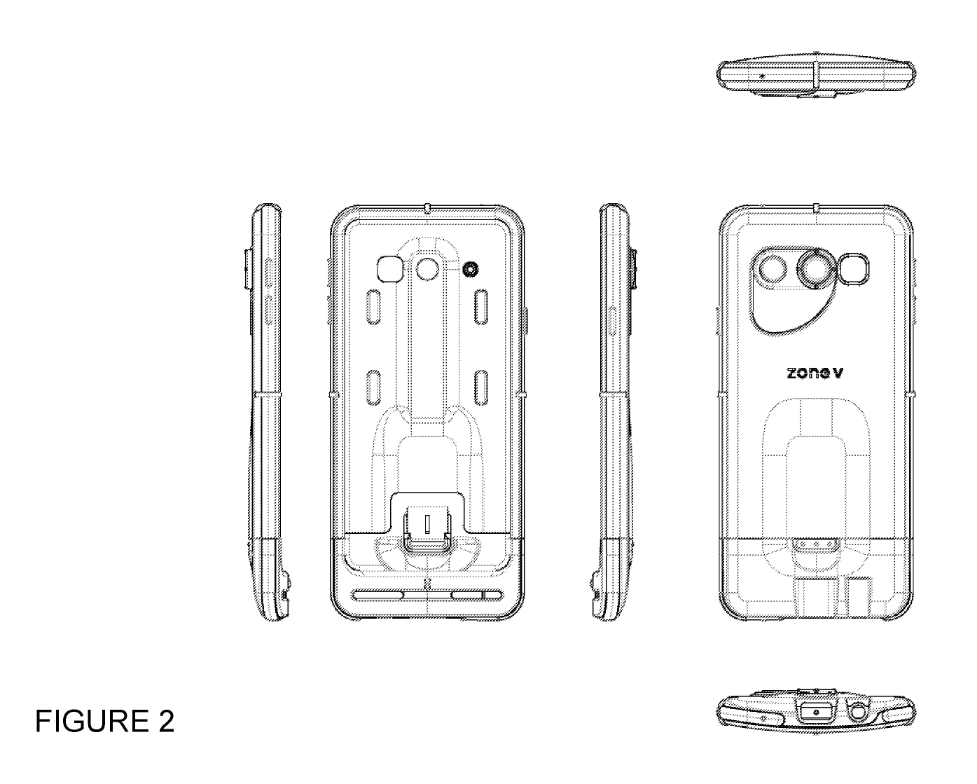

FIG. 2 shows different views of a protective case designed for a portable electronic device, which incorporates a number of features to assist a visually impaired or elderly end-user.

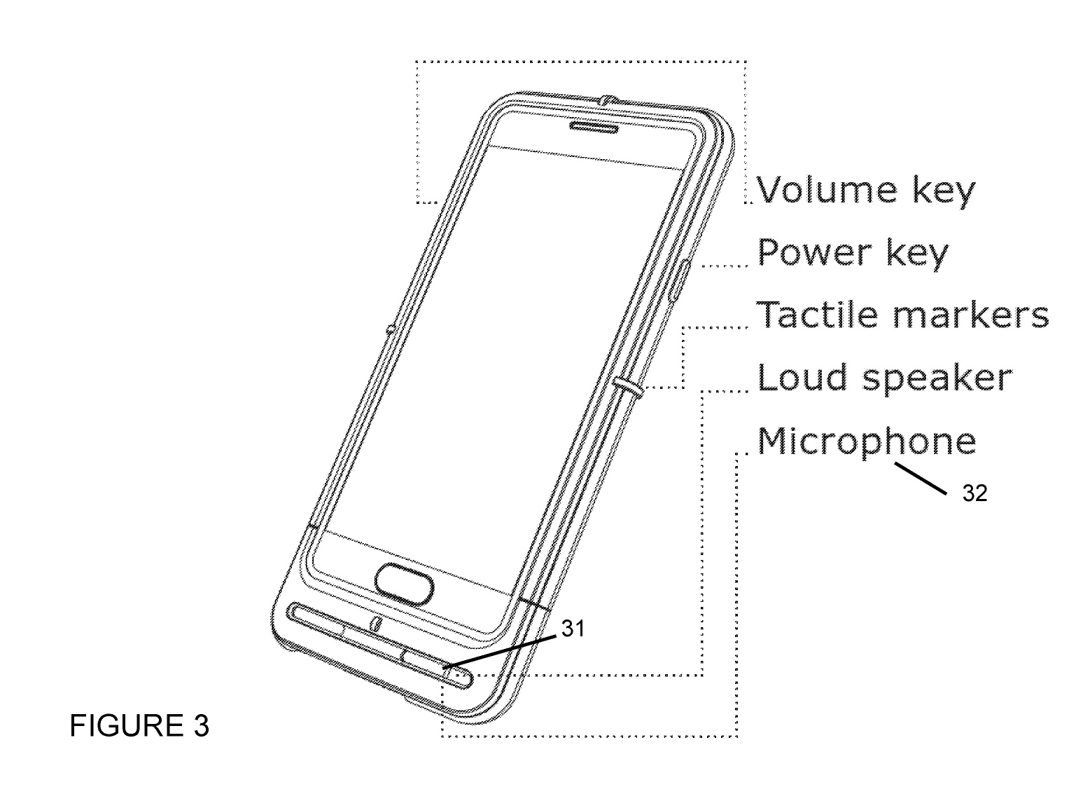

FIG. 3 shows a front view of a protective case when assembled on a smartphone or portable electronic device. The protective case provides feedback to an end-user that is interacting with the portable electronic device. Feedback includes for example tactile feedback and/or vibration feedback. Tactile feedback includes tactile markers that facilitate the navigation by the end-user of the features of the portable electronic device. The front side of the protective case may also include one or more of the following: volume key, power key, a loudspeaker and/or a microphone.

The case comprises an opening that aligns with the speaker of the electronic device (31). The case is configured for enhancing sound delivered from and/or into the electronic device. The case comprises a cavity placed near the opening that is configured to bend the sound coming out of the speaker and to project it towards the front of the electronic device.

The case comprises another opening (32) that aligns with the microphone of the electronic device, and that is configured to provide optimum sound delivered by an end-user into the electronic portable device.

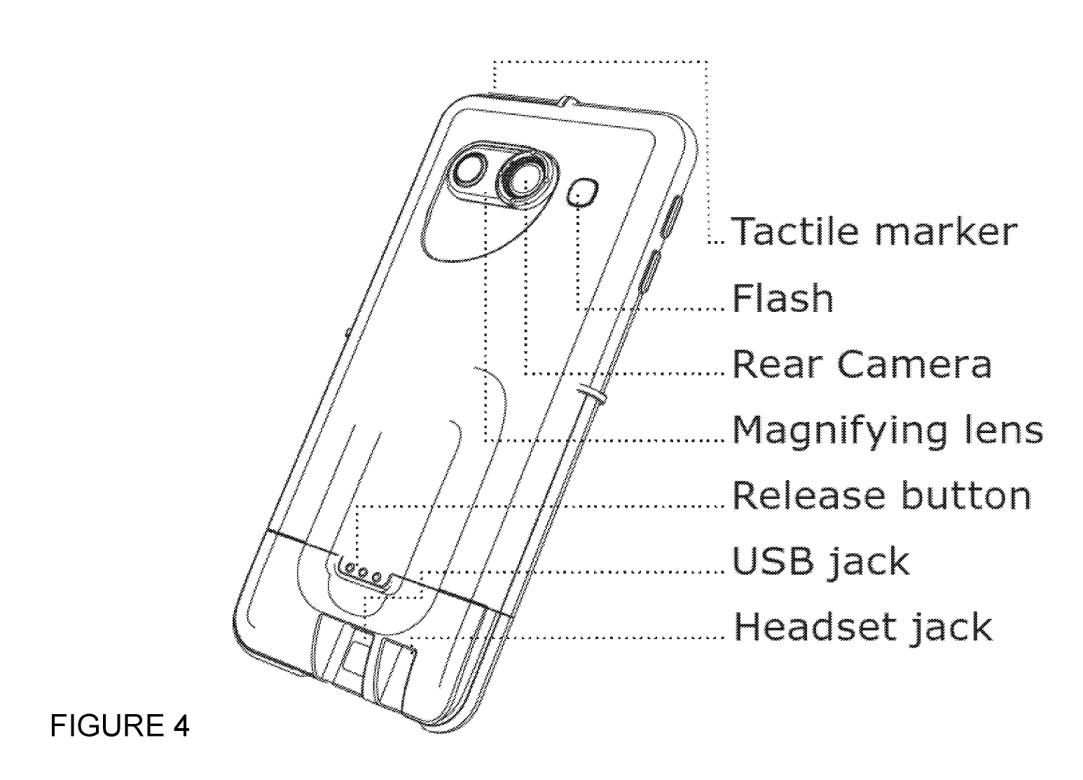

FIG. 4 shows a back view of a protective case when assembled on a smartphone. The backside of the protective case includes one or more of the following: tactile marker(s), a flash, a rear camera, a magnifying lens, a release button, a USB jack and/or a headset jack.

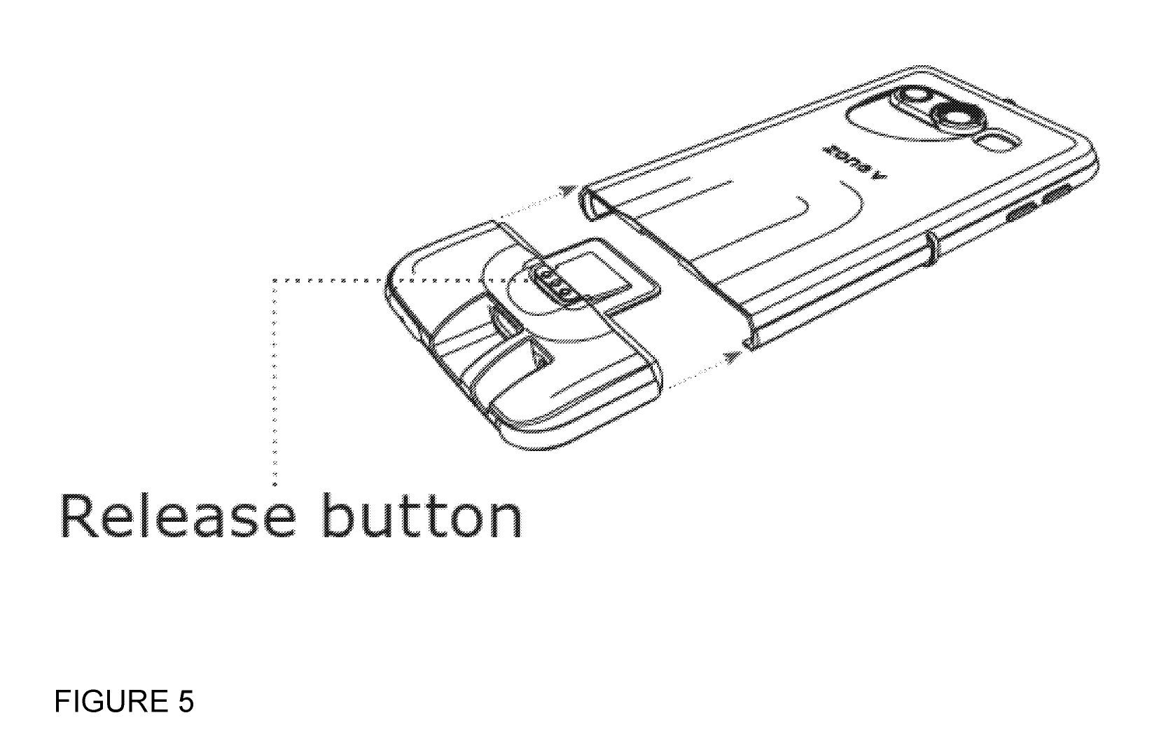

FIG. 5 shows a protective case comprising a first case portion and a second case portion. The first and second portions are connected mechanically or via magnets or by any other means. As an example, the second case portion can be removed from the first case portion by activating a release button placed on the second case portion. Hence, the second case portion is interchangeable and can be removed from the smartphone without having to remove the first case portion.

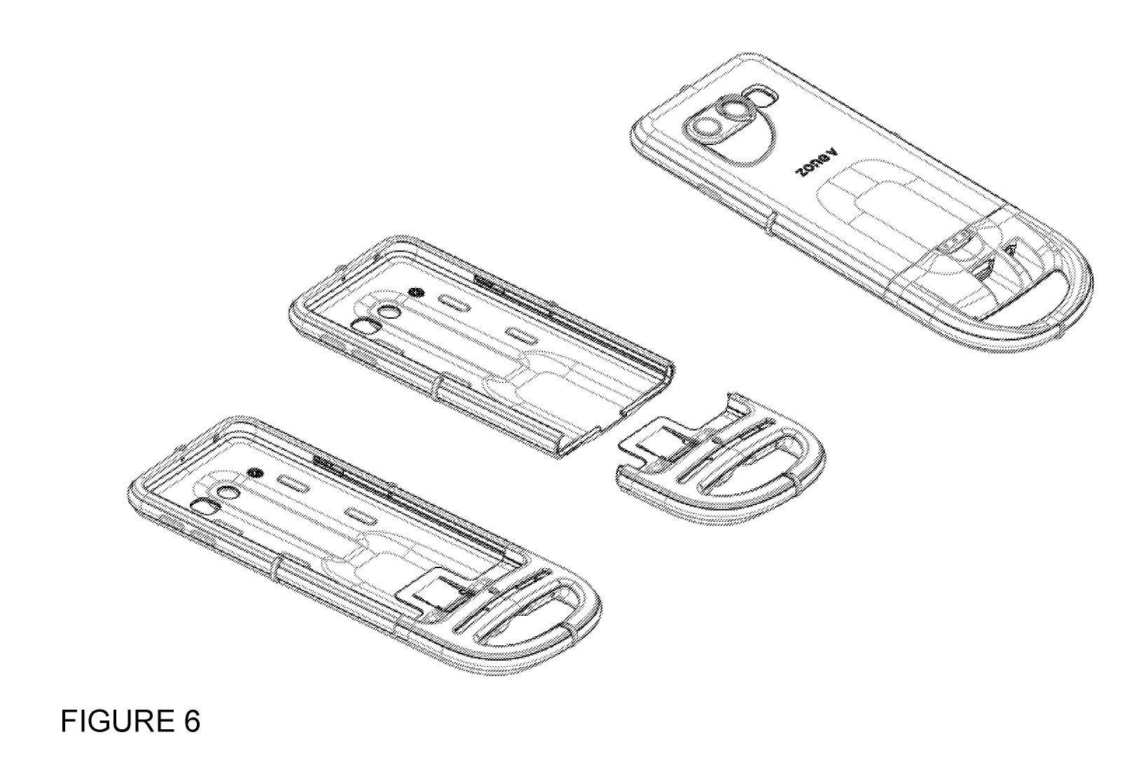

FIG. 6 shows another configuration wherein the protective case comprises a hand grip. The hand grip is configured for easier handling of the portable electronic device and may also take the form of a square grip or a loop grip.

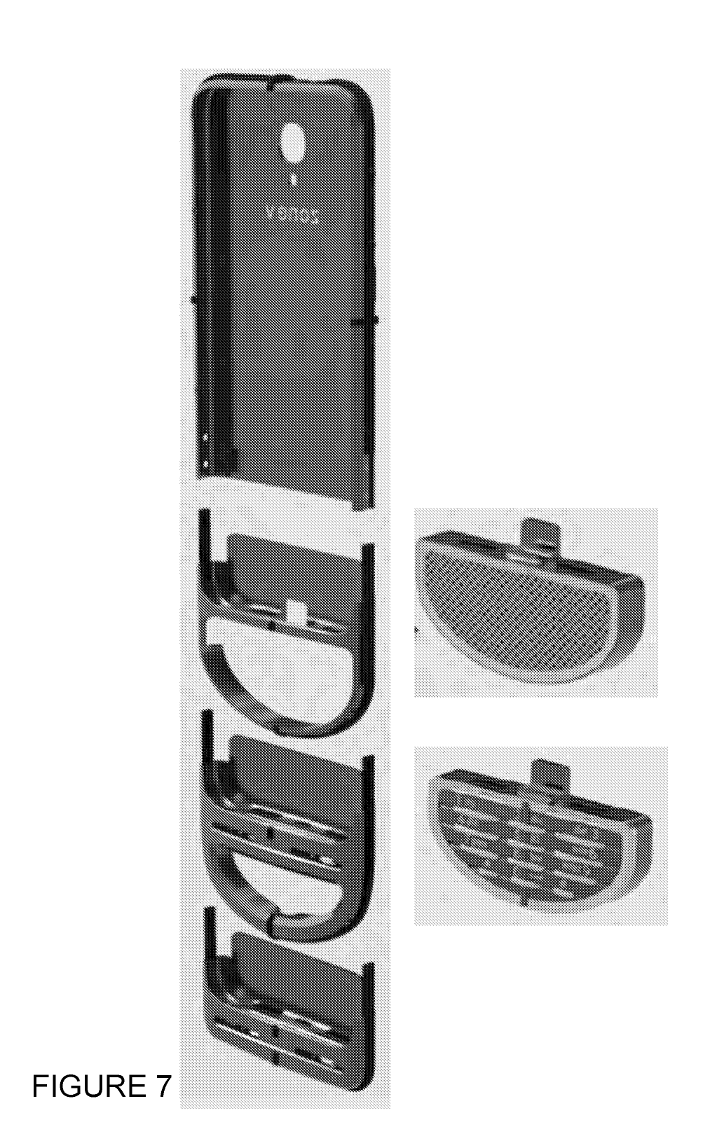

FIG. 7 shows further examples of accessories that may be attached and/or detached from the protective case. Accessories include but are not limited to: a mirror, a camera lens, a hand grip, a keyboard, a braille button or keypad, haptic actuator, an emergency button, one or more buttons corresponding to pre-defined speed dial numbers, a torch, a speaker, an extra battery, a wireless charging dock, a reading light, a stand for video conferencing, a RFID for door entry, an area for writing vital info similar to an ID card, a Wi-Fi hotspot, a car key entry, a barcode scanner, a navigation touchpad, a TV remote control, an enhanced camera, a programmable hearing aid interface, a laser distance measurement device (virtual cane), any health or activity monitoring sensors or any other sensors.

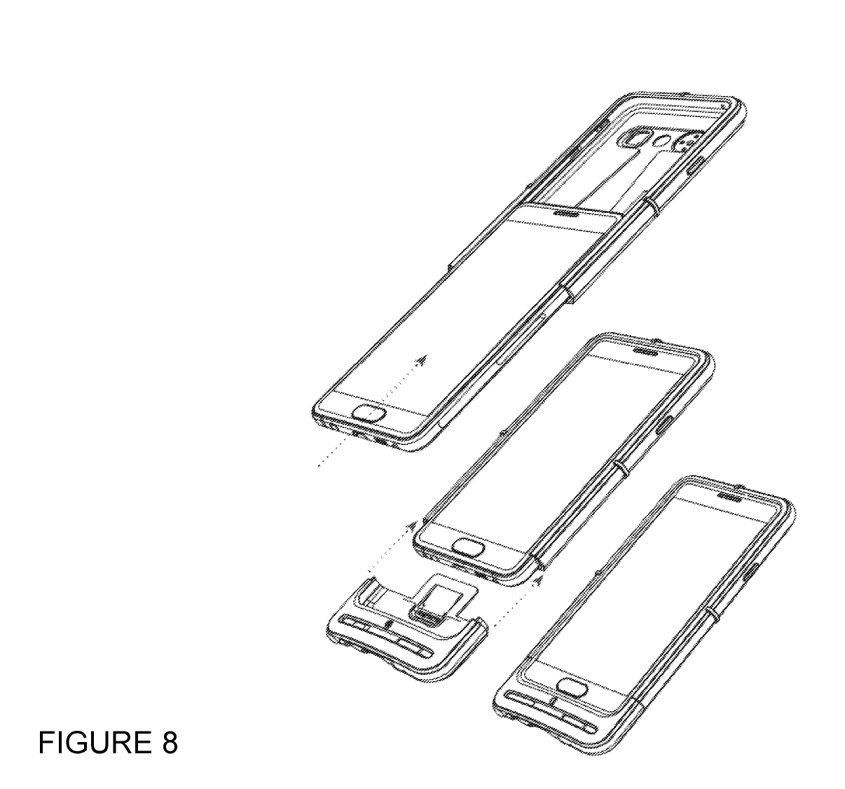

FIG. 8 shows the steps for assembly of a protective case on a portable electronic device. Examples of portable electronic devices include the following: a smartphone, a tablet, a video-game device, a music player, an e-reader or an electronic toy.

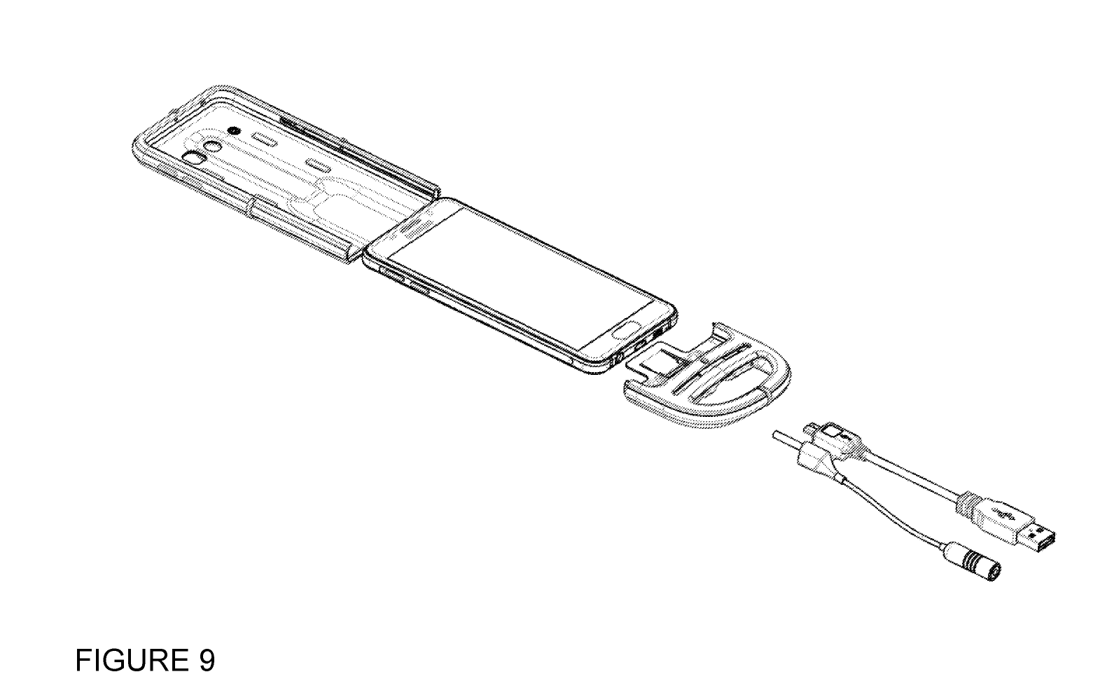

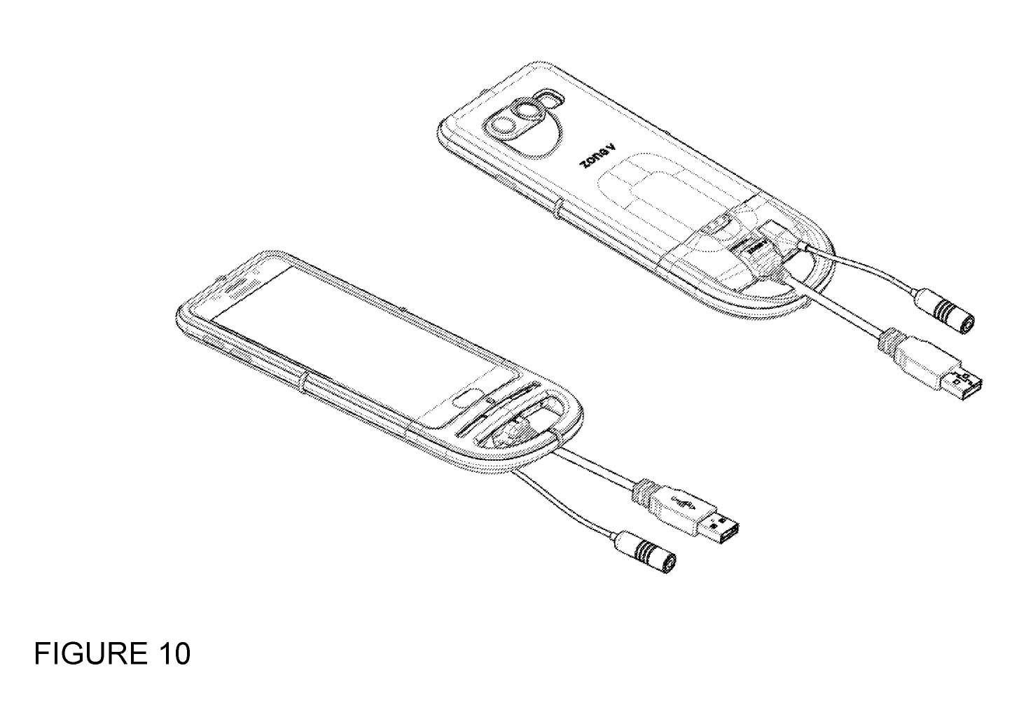

FIGS. 9 and 10 show illustrations with the case and additional accessory cables, a USB cable and a headset jack connector. The protective case includes openings for a USB socket and for a headphone jack socket.

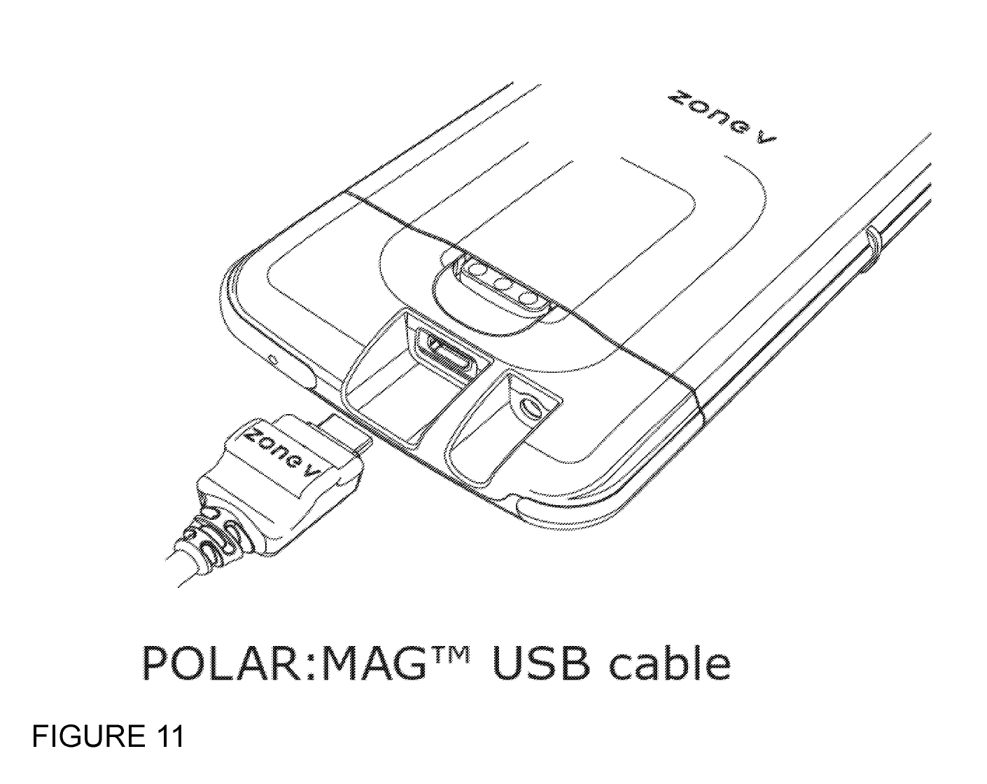

The case includes a magnetic or metal element located adjacent to the opening of the power socket as shown in FIG. 11. The USB cable also has a magnetic or metal element that is magnetically attracted to the element located near the USB socket opening. Thus, the USB cable is then magnetically drawn into place while it is positioned near the USB socket. The case and USB cable are both configured such that it is not possible to connect the USB cable on the smartphone upside down.

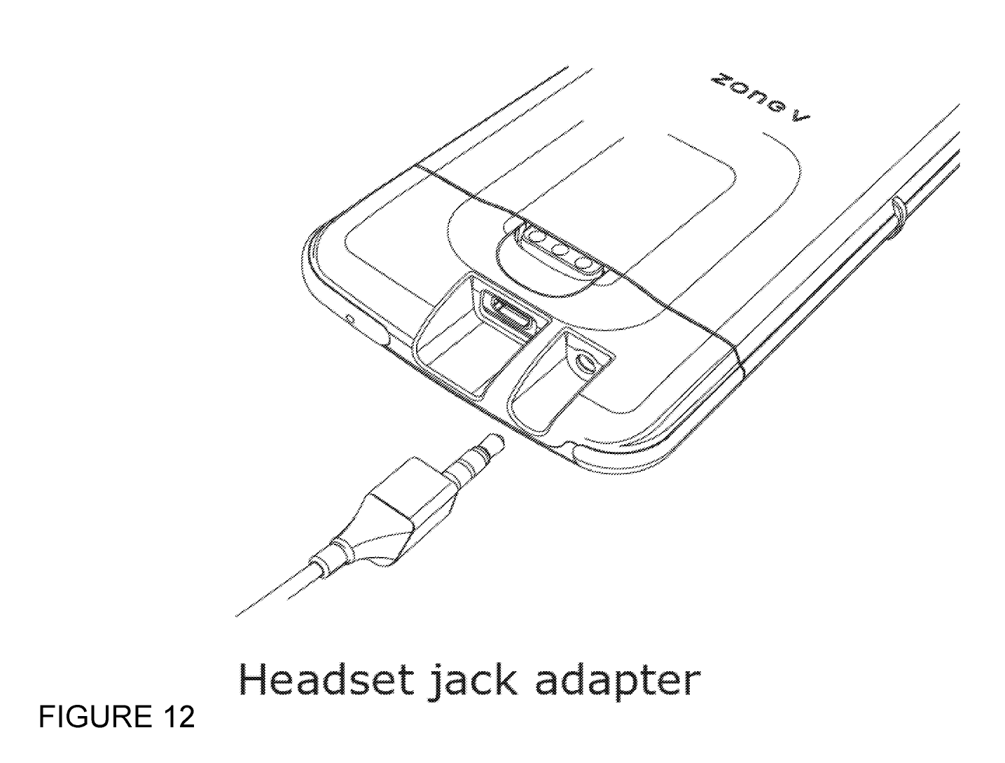

FIG. 12 shows a case and a headset jack adapter that is configured to match the opening of the case adjacent to the headset jack socket. The headset jack adapter has a small magnet to enable easy connection into the smartphone headset jack. The case and headset jack adapter are both configured such that it is not possible to connect the headset jack adapter on the headset jack socket of the smartphone incorrectly.

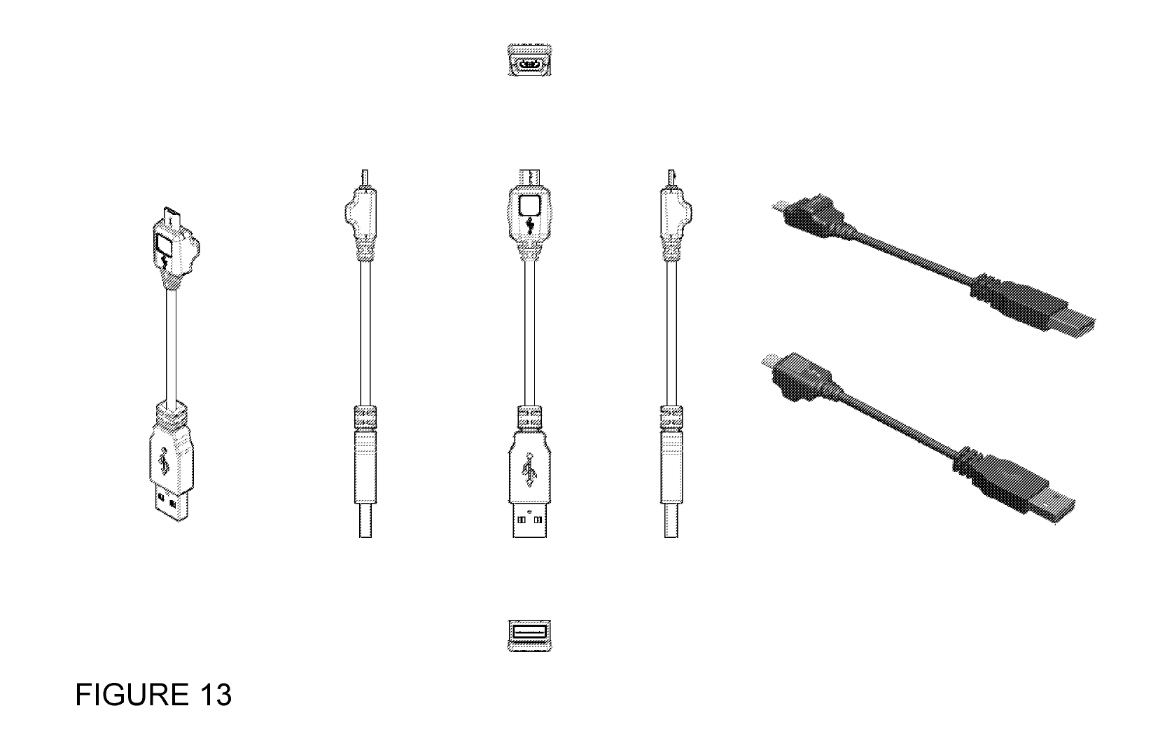

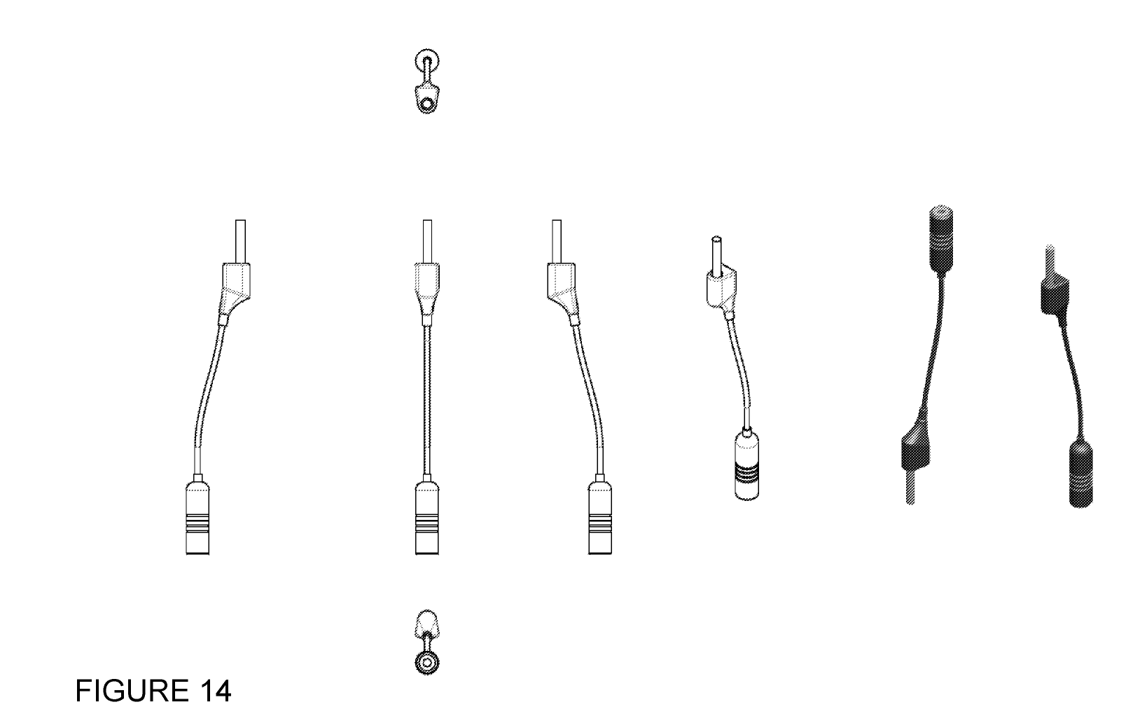

FIG. 13 shows different views of the USB cable and FIG. 14 shows different views of the headset jack.

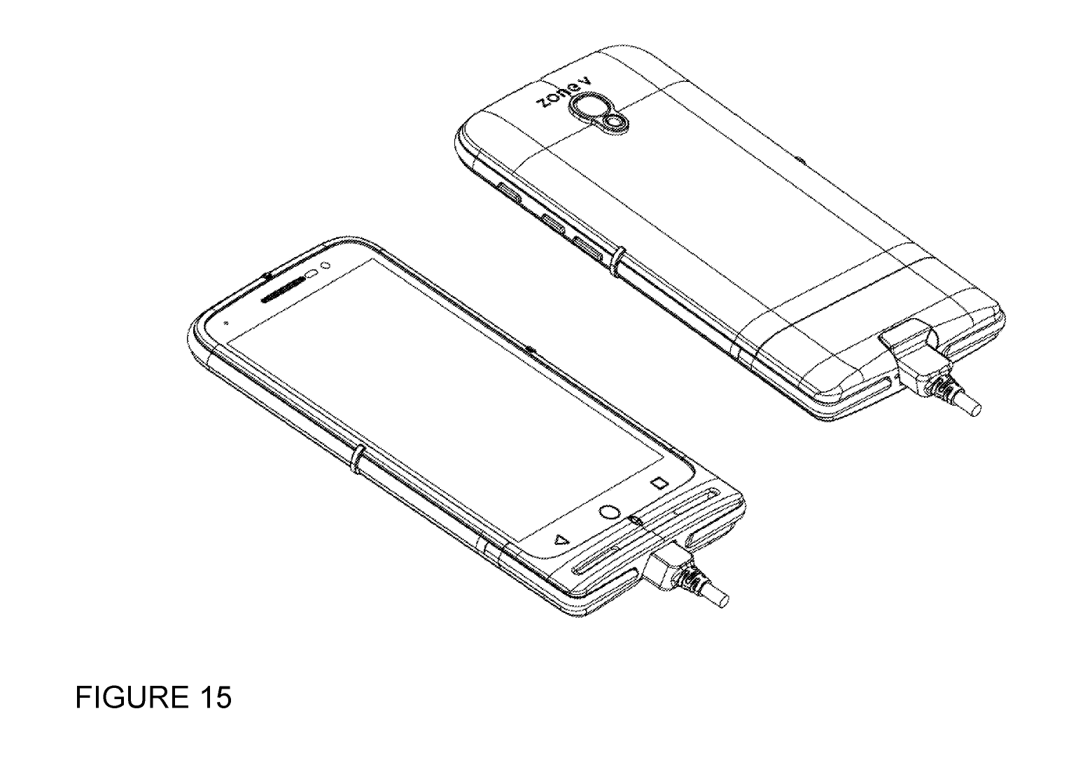

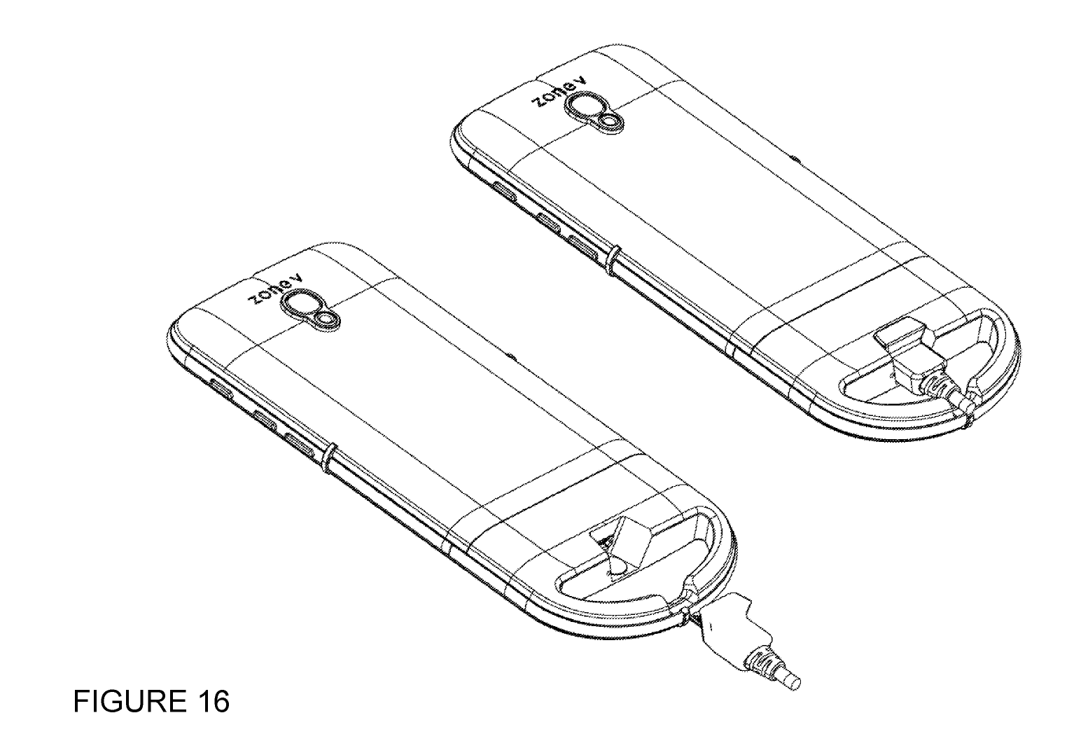

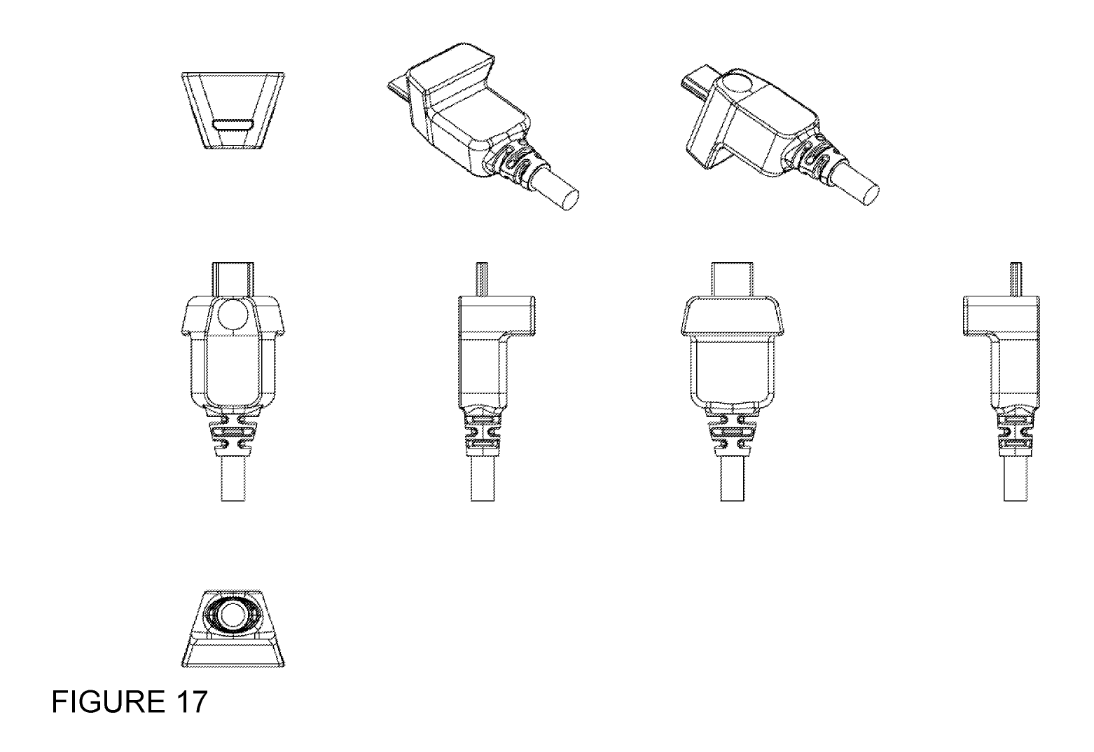

FIGS. 15 and 16 show diagrams with another example of a protective case assembled on a smartphone. The protective case includes an opening for a USB cable and the case comprises an opening that is configured to match the USB cable socket. FIG. 17 shows diagrams with different views of a USB cable connector.

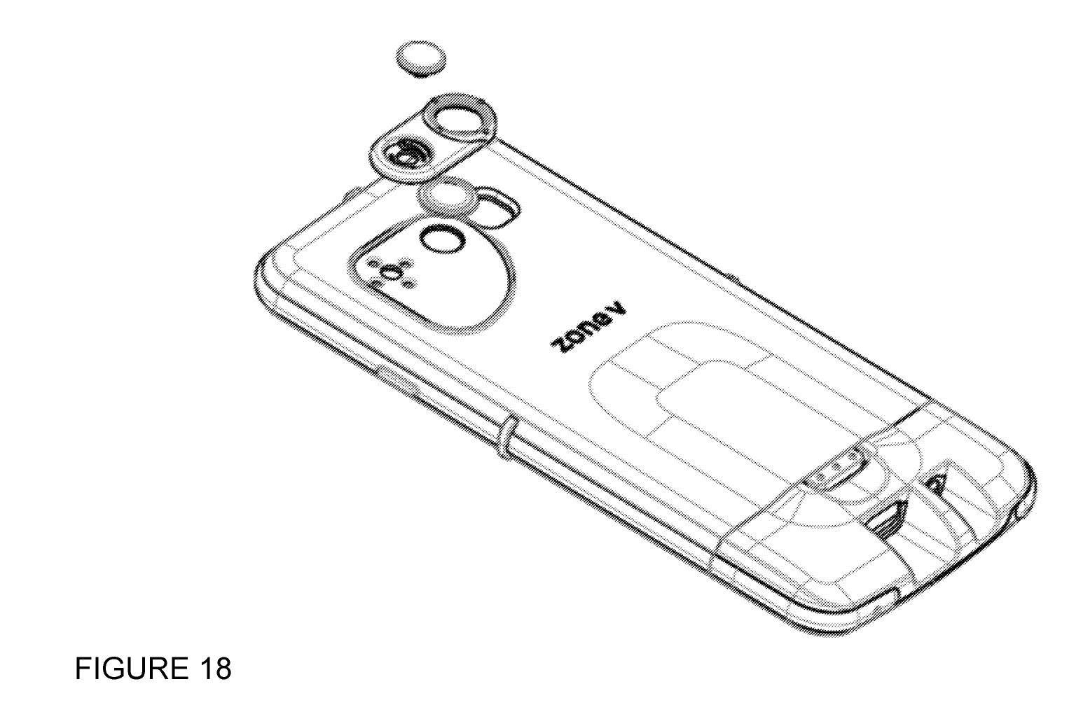

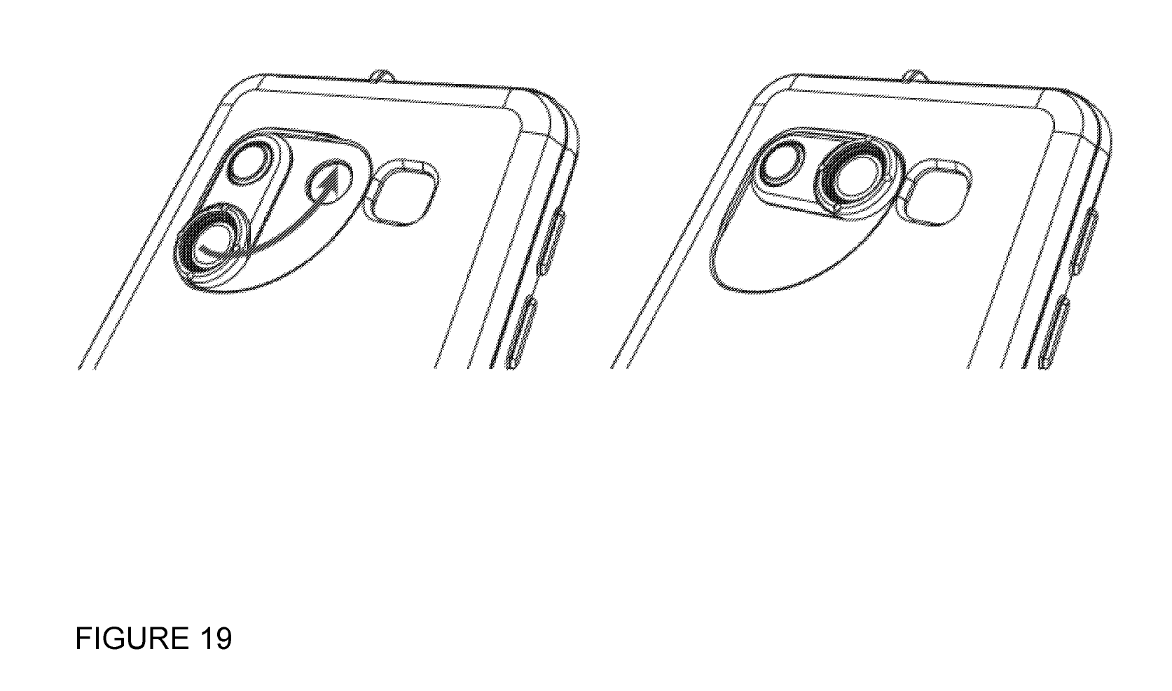

FIG. 18 shows a case for a smartphone comprising an additional lens. As seen in FIG. 19, the additional lens can be moved into position over a camera lens integrated into the smartphone. The additional lens is fully integrated with the case. The lens can be placed over the camera lens via a slide or by any other means. The lens may be one of the following: a magnifying lens, a wide-angle lens or any other optical lens.

Software Application that is Configured to Work Seamlessly with the Protective Case

Another aspect of the invention is a software application that is executable on a portable electronic device such that the device can switch to another and simpler user interface as illustrated in the following figures. The software application is configured to work seamlessly with the protective case described above when the protective case is placed on the portable electronic device.

The Zone V project utilizes a user interface (UI) overlay provided in the form of an .apk (Android Application Package File) launcher or any other equivalent launcher.

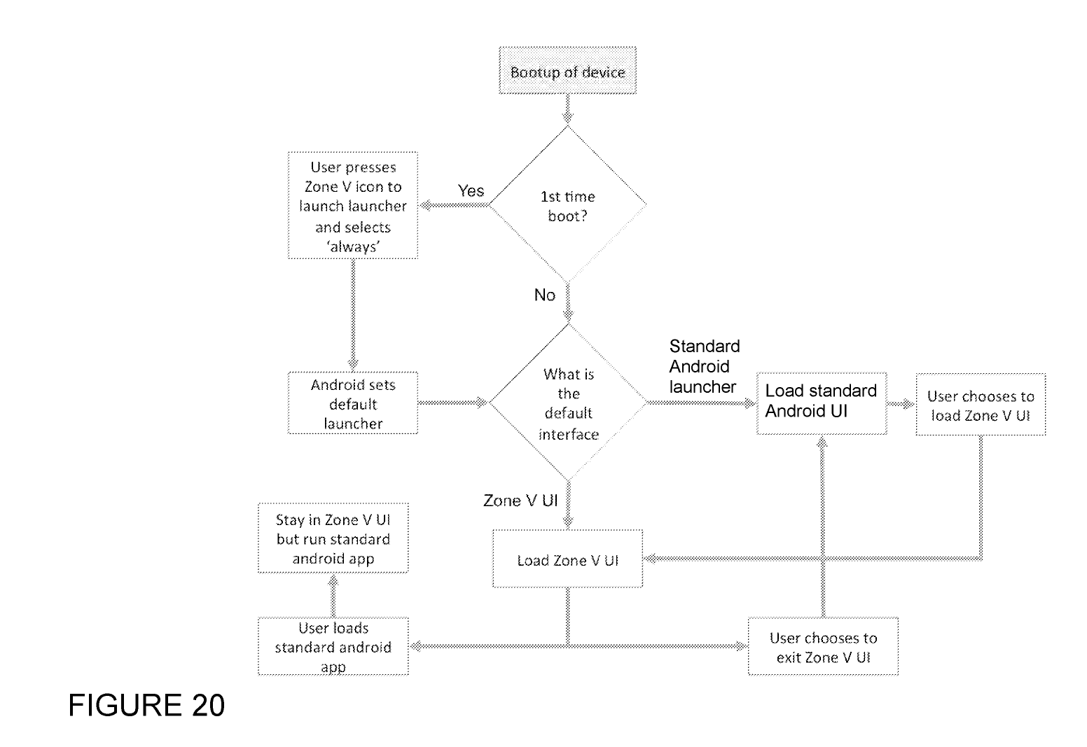

With reference to FIG. 20, when the device is first turned on, it first boots into the factory installed graphical user interface. On the home screen, a large widget with a Zone V icon is placed such that, when pressed, the Zone V user interface is launched. The end-user is then presented with the option to ‘Always’ select this launcher. If ‘Always’ is selected, the Zone V software application will then be automatically executed when the device is switched on or unlocked. Once in the Zone V UI, the user may exit into the factory installed launcher through an option in the settings menu. A user may also load a standard 3^{rd} party application through the Zone V UI. One key feature of this approach is that a standard Android or equivalent application can be ran directly through the Zone V UI and can exit back into the Zone V UI after exiting the app.

Additionally, the first boot up may present users with a series of questions that will determine the configuration mode of the Zone V handset. The first page may then load a menu corresponding to different visual modes, such as, but not limited to: stock android mode, senior mode, visual impairment mode, no sight mode or advanced configuration mode.

The Zone V software application is configured to work seamlessly with the protective case described above when the protective case is placed on the portable electronic device. The features available on the protective case such as the function keys may provide different feedback based on the context. Hence for example in no sight mode, the up and down function keys may act as page up/down and in senior mode, they may provide zoom in/out functions.

In addition, a visual mode may generate a high contrast black and white image or alternative colours in order to give optimal contrast and clarity. Another visual mode may invert black and white. The different visual modes may also generate different font sizes pre-selected by the end-user for one or more menu items. Generally, the visual modes provide enlarged text in order to make text easier to read for an end-user. Different font sizes for one or more web sites or apps that support dynamic font re-sizing may be available through the visual modes. One configurable setting also provides for the font size to be changed automatically in all the web sites or apps that supports dynamic text sizing.

As an example the senior mode takes advantage of the large text and easy to use menu system. The senior mode has the following default settings:
Selection method: single tap;
Voice feedback: disabled;
Haptic feedback: enabled;
Scrolling: standard list scroll.

The visually impaired mode takes advantage of the grid system and audio feedback. The visually impaired mode has the following default settings:
Selection method: double tap;
Voice feedback: enabled;
Haptic feedback: enabled;
Scrolling: side buttons.

The advanced configuration mode has the following configurable settings:
Voice feedback (TalkBack) on/off;
Volume level: ring tone, notifications & talk back;
Haptic intensity level on/off;
Scrolling method: standard list scroll or side buttons;
Selection method: single or double tap.

The default profiles can be adjusted by the end-user in order to customize the end-user experience. The following may be customised:
Inverted colours—black on white vs. white on black;
Selection method—select single tap or double tap;
Voice feedback—on/off & volume setting;
Haptic feedback—on/off & level of intensity;
Scrolling—Standard android scroll or side buttons;
Changing of font sizes—increase font size across UI.

In addition to the graphical interface, integral to the operation of the device is the ability to allow for TalkBack to be enabled throughout the device if the user has chosen to switch this service on.

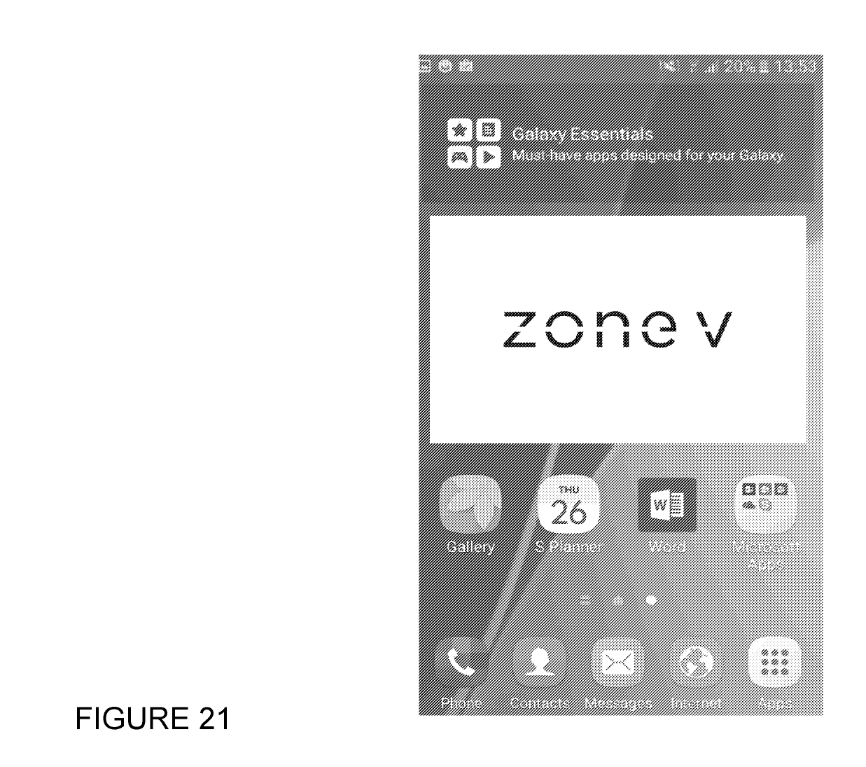

FIG. 21 shows the widget of the software application with a Zone V icon as seen on the factory installed graphical user interface. By clicking on the widget, the software application is executed on the smartphone and the graphical interface is switched to another simplified graphical user interface (Zone V) that displays all text in an enlarged font size and alters the appearance of all menu items to increase legibility.

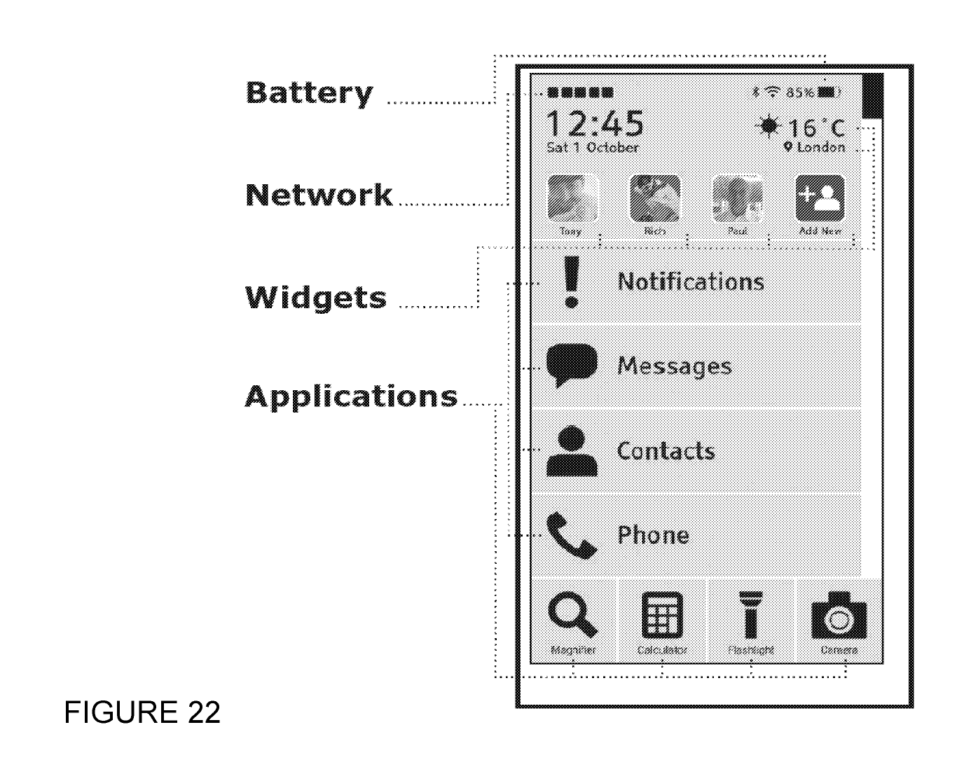

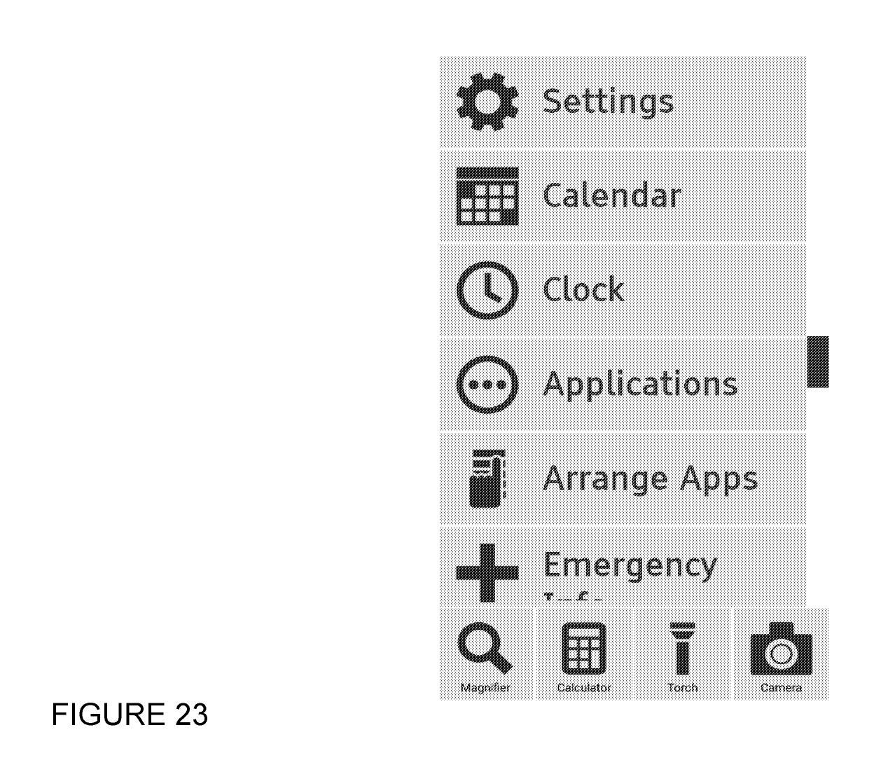

FIGS. 22 and 23 show the home screen of the simplified graphical user interface that is split into zones. The zones may also be colour coded. The home screen shows top-level menu items. Menu items at the top level may include one or more of the following: messages, contacts, phone, settings, calendar, clock, applications, arrange apps, emergency contact, any pre-selected app, email, internet, GPS, video tutorial, exit.

The user interface also provides a fixed bottom menu, which displays four icons for easy access of pre-defined items, for example: magnifier, calculator, torch and camera.

The top-level menu items displayed on the home screen may be turned on or off. By clicking, tapping or selecting via voice control one of the menu items, further specific functions are accessed.

An end-user will be provided with the ability to choose home screen items. Within the settings of the Zone V user interface, the user will have the ability to order items on the home screens, allowing for customisation for easy access to most used applications, including 3^{rd} party applications.

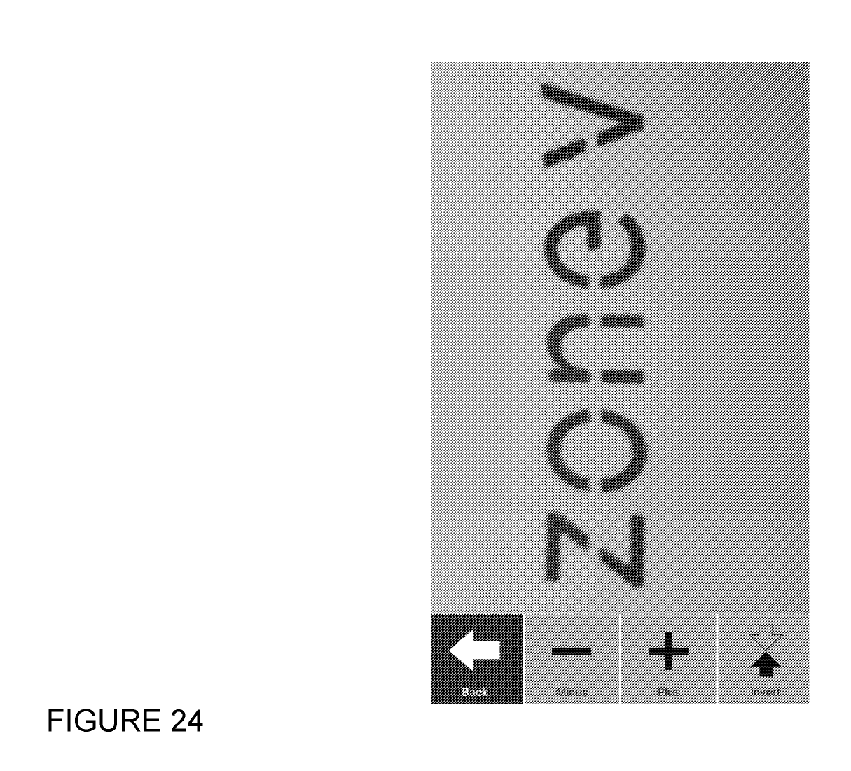

FIG. 24 shows a screenshot of the graphical user interface when the Magnifier mode is selected which enables a magnified image or text to be shown directly on a smartphone. One visual mode automatically inverts the colour of the image in order to aid readability. Increase magnification (+) or decrease magnification (−) may also be selected. An image mode and a video mode may be available.

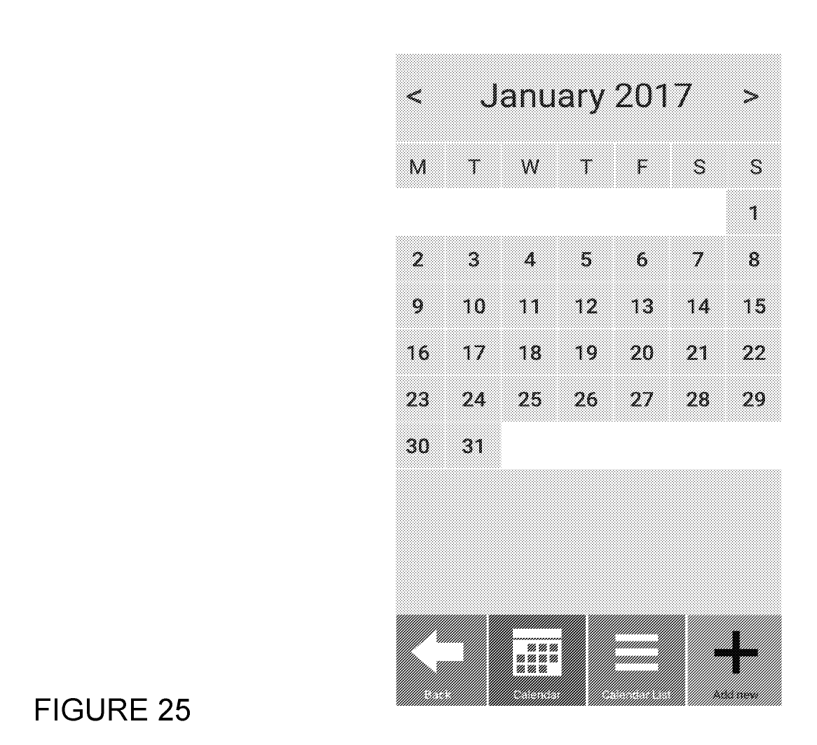

FIG. 25 shows a screenshot of the graphical user interface when the Calendar mode is selected. The calendar may also feature a list view or a month view.

A clock menu item can also be selected. The clock may include an alarm function and may read out the time as well as the alarm. The clock application will also have a reminders function that allows for the creation of reminders for regular (or single) events with notes.

A location app can also provide users with details about the locations of interest that are in the vicinity and which may feature: a direction service (with the ability to enter an address and get directions in text or voice format), a compass, nearby points of interest listing nearby locations.

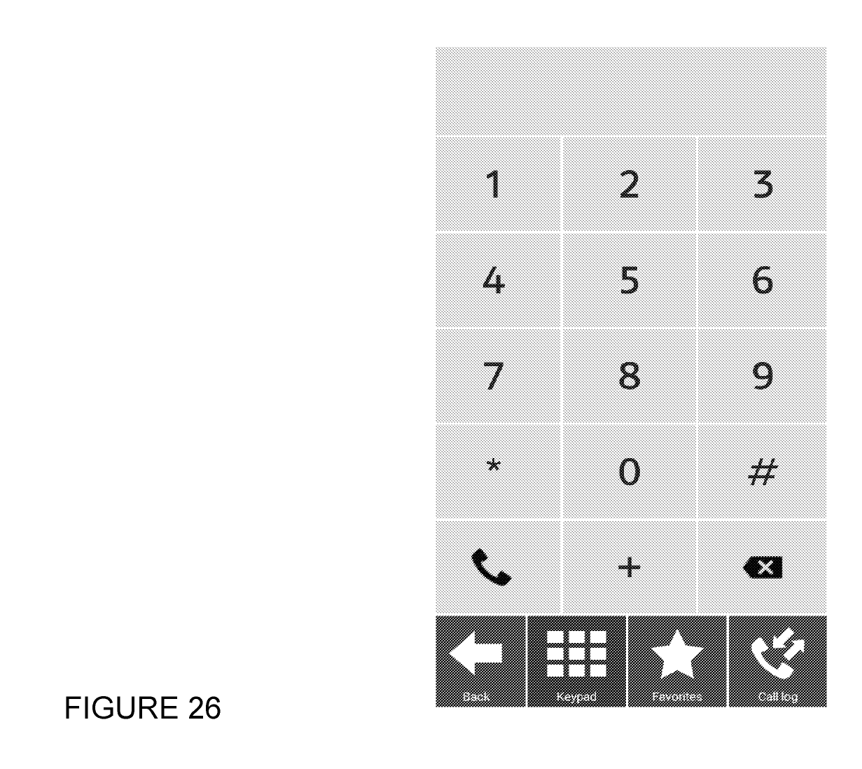

FIG. 26 shows a screenshot of the graphical user interface when the Phone mode is selected.

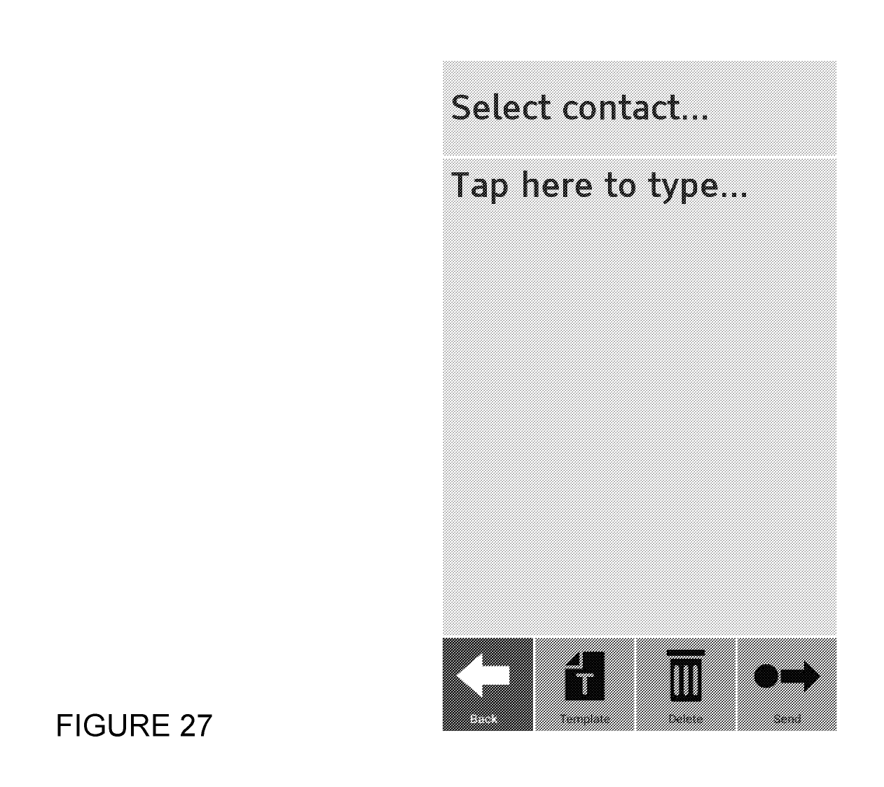

FIG. 27 shows a screenshot of the graphical user interface when the Messages mode is selected.

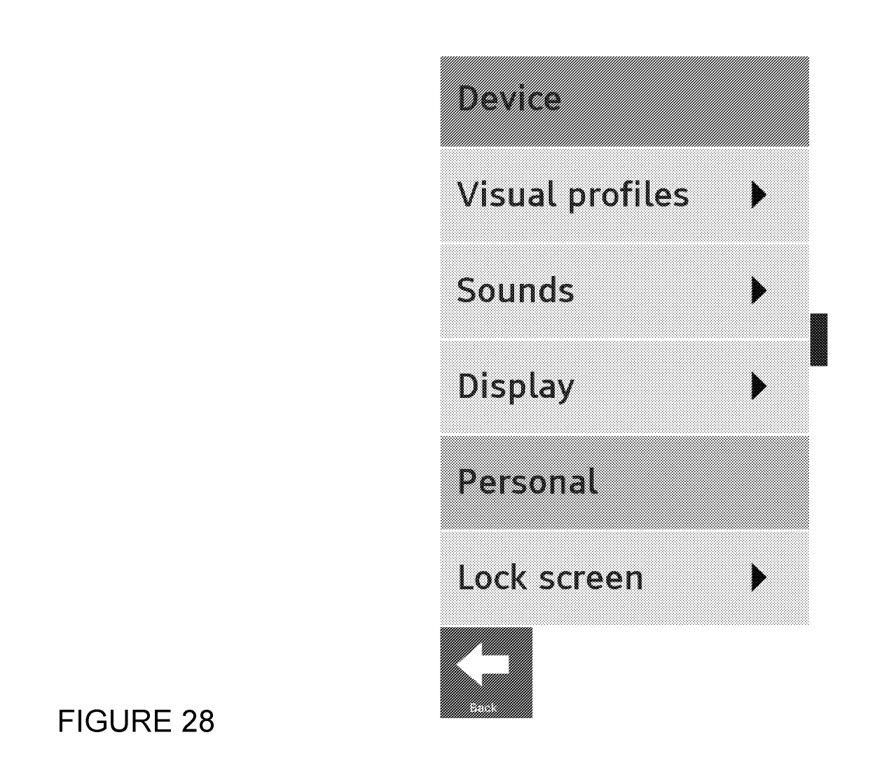

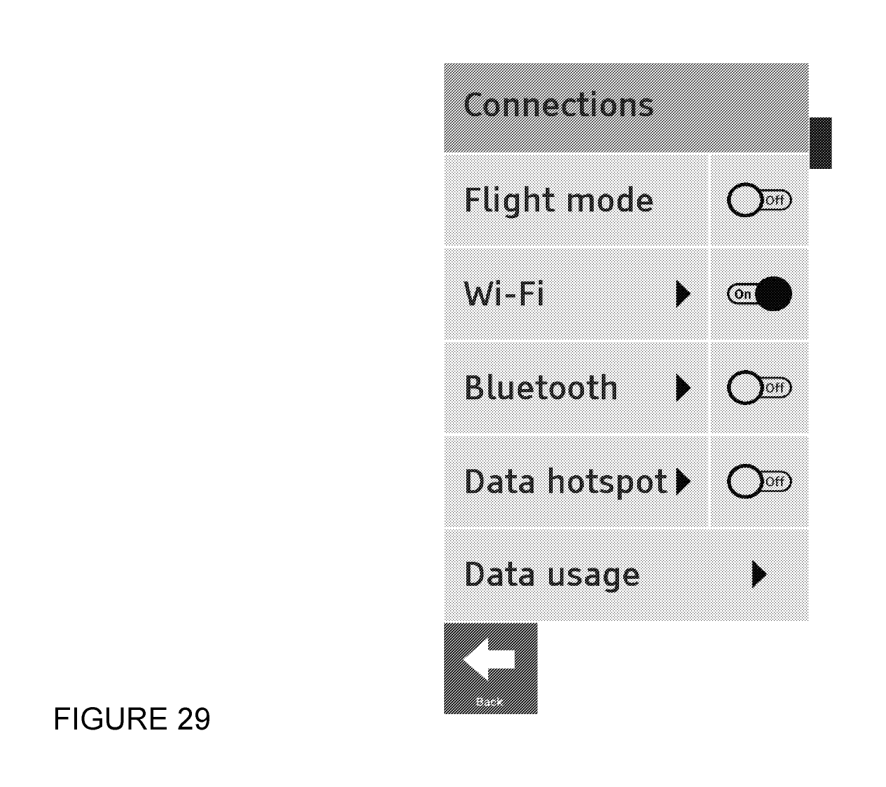

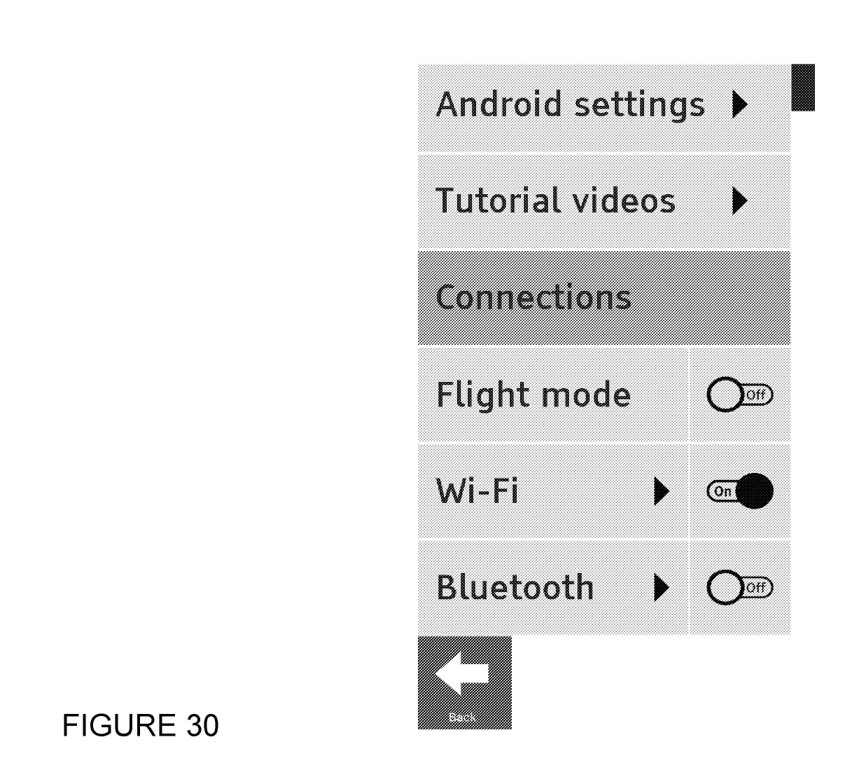

FIGS. 28 to 30 show screenshots of the Settings menu split into zones. Settings menu items are arranged into rows, which can be vertically scrollable with a touch swipe up or down to reveal, other menu rows.

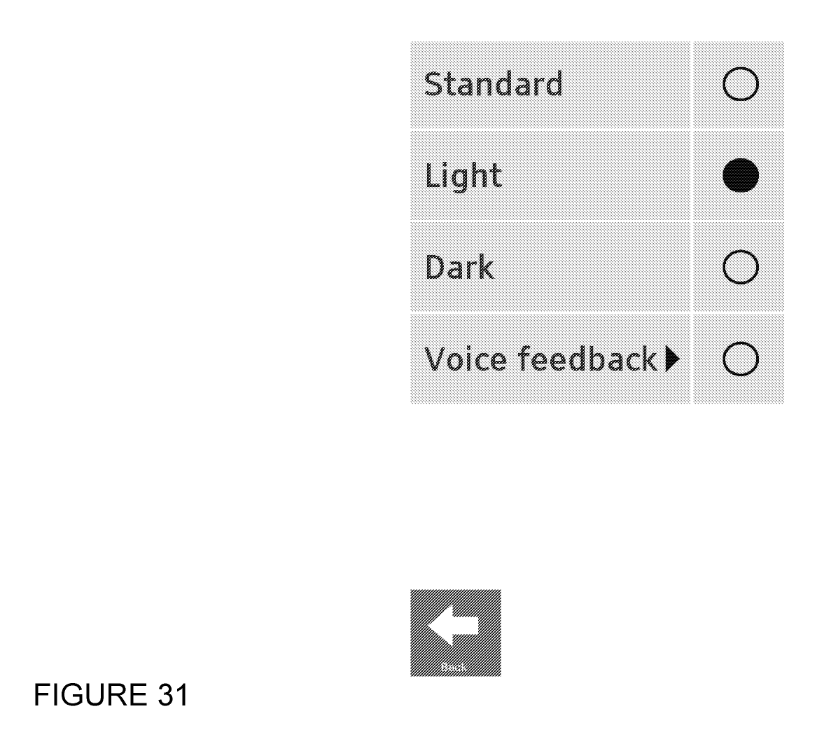

FIG. 31 shows a screenshot of the visual profiles available through the Settings menu. An example of four profiles is given: standard, light, dark and voice feedback, which have been designed to give optimal contrast and clarity.

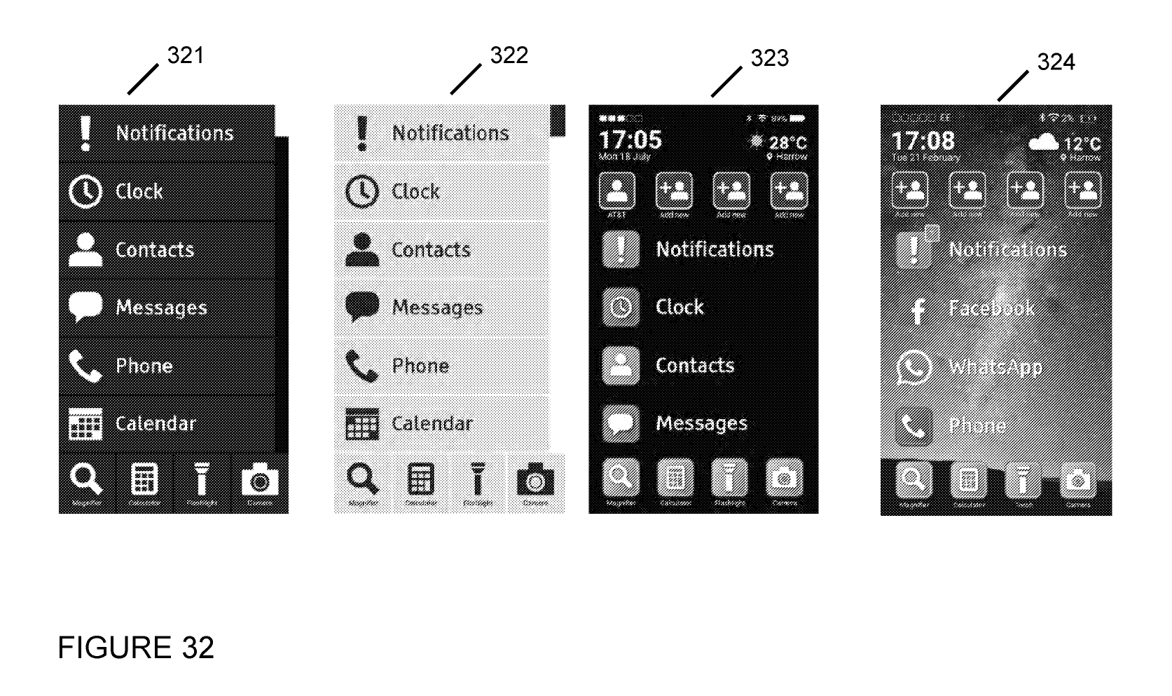

FIG. 32 shows screenshots with home screens of a number of visual profiles: dark (321), light (322), standard (323) and standard with wallpaper (324).

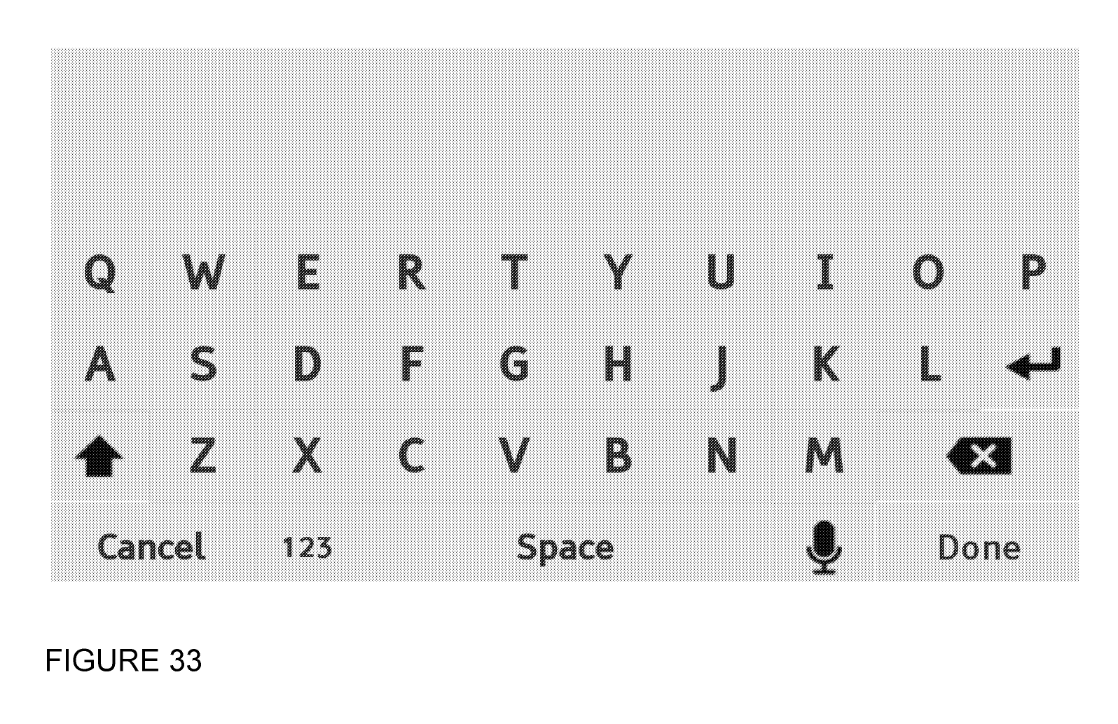

FIG. 33 shows a screenshot of the keypad.

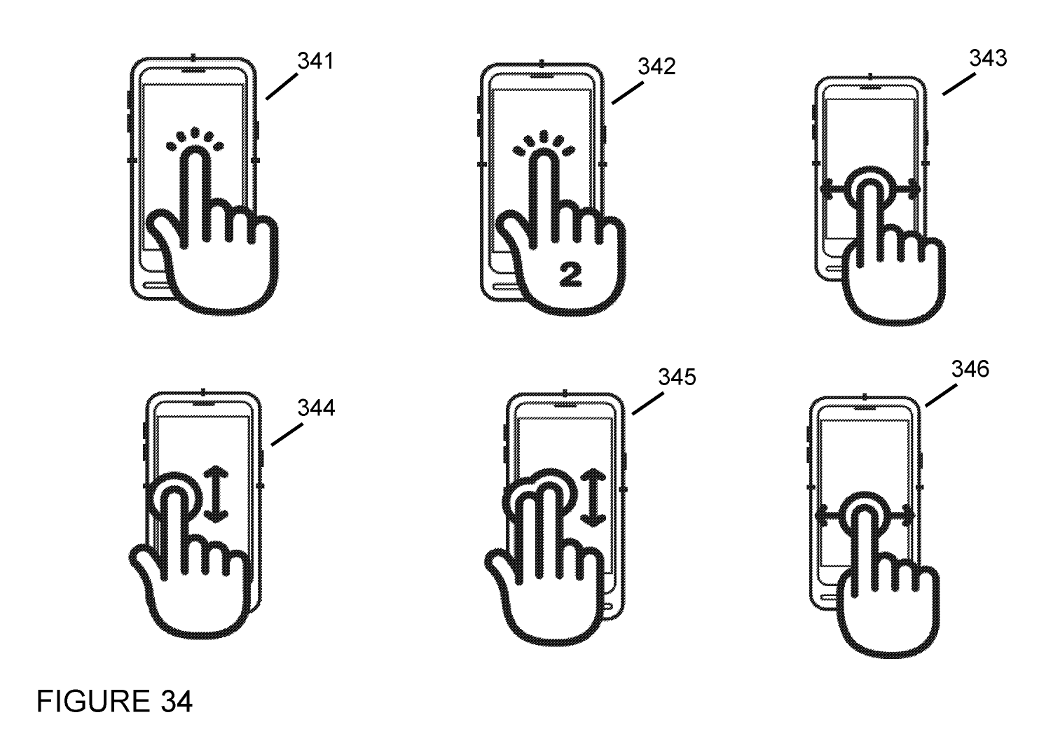

FIG. 34 shows different actions or gestures that may be performed by an end-user to interact with the smartphone, for example:
tap (341): tap your devices screen to enter an application, complete an action, activating an on/off switch or entering letters using the key board.
double tap (342): when the voice feedback profile has been selected, a double tap (342) may be used to enter an application, complete an action, activate an on/off switch or enter letters using the key board.
swipe (343): Using your index finger swipe (343) to the left or right such as when using the gallery,
scroll (344): When in standard, light or dark mode, place one finger on the screen and move your finger up and down the screen to scroll through a list of information.
scroll (345): When the voice feedback profile has been selected, place two fingers on the screen and move your fingers in parallel up and down the screen to scroll.
Tap and drag (346): using your index finger tap and drag the icon in the direction of the arrows such as when answering or rejecting a call.

### Zone V Downloading, Installation and Registration

Secure software downloading to mobile phones from websites often requires the inputting of unique keys to prevent fraud. The process can be complex and is not easily useable by non-technical consumers. The Zone V install process makes downloading, installation and registering significantly simpler for the user.

A simplified installation process has been developed in order to significantly simplify the downloading of the Zone V software. It can be used wherever software needs to be installed on a portable electronic device, especially one with wireless connectivity.

Key features of the process include, but are not limited to:
use of an NFC sticker, for example inserted in the user guide, in order to trigger the smartphone to navigate to the download site.
integrated code to show install button once the download is complete;
use of a bar code reader integrated into the registration process to load the security code.

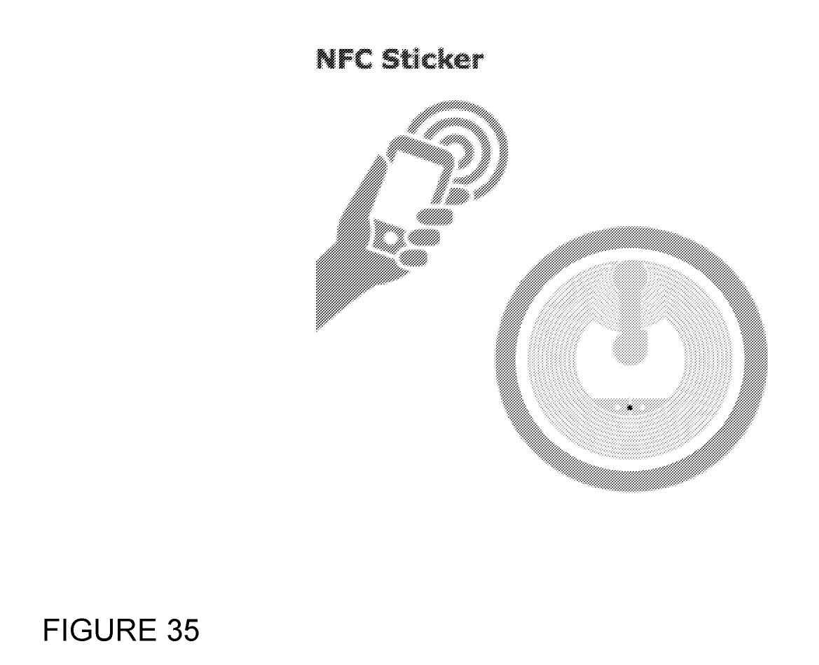

FIGS. 35 to 43 illustrate the key steps of a Zone V software downloading installing and registration process on a portable electronic device.

FIG. 35 shows a diagram illustrating an electronic portable device that has an NFC chip and that is tapped near or on another NFC sticker, for example placed on an installation guide, in order to launch a selected Internet browser.

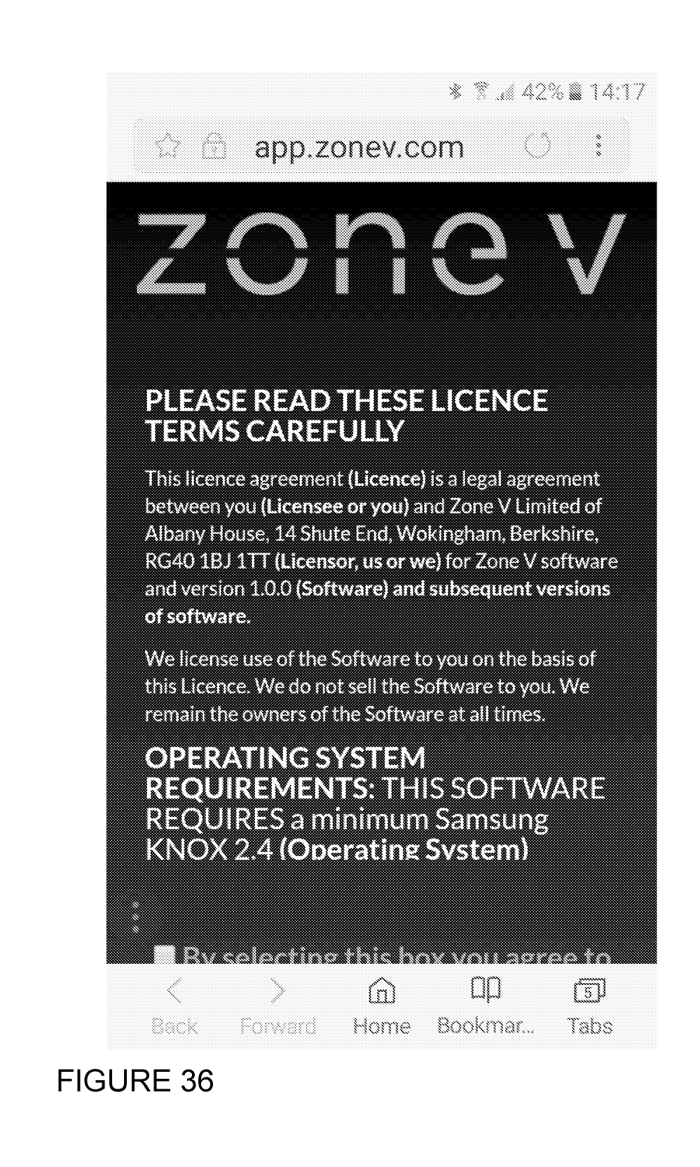

FIG. 36 shows a screenshot with the selected Internet browser that has been launched after tapping the phone near the NFC sticker, and that is displaying terms and conditions of the Zone V software Licence.

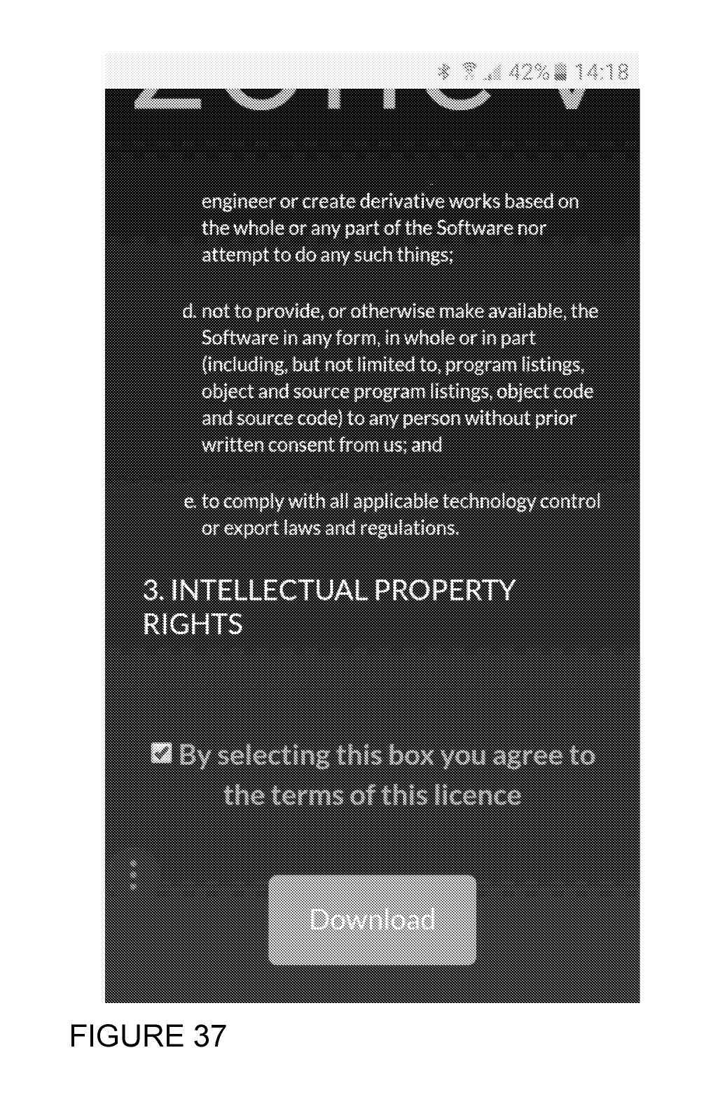

FIG. 37 shows a screenshot with the selected Internet browser displaying a checkbox that can be selected in order to agree the terms of the Zone V software licence. Once the box is selected, the download of the Zone V software begins.

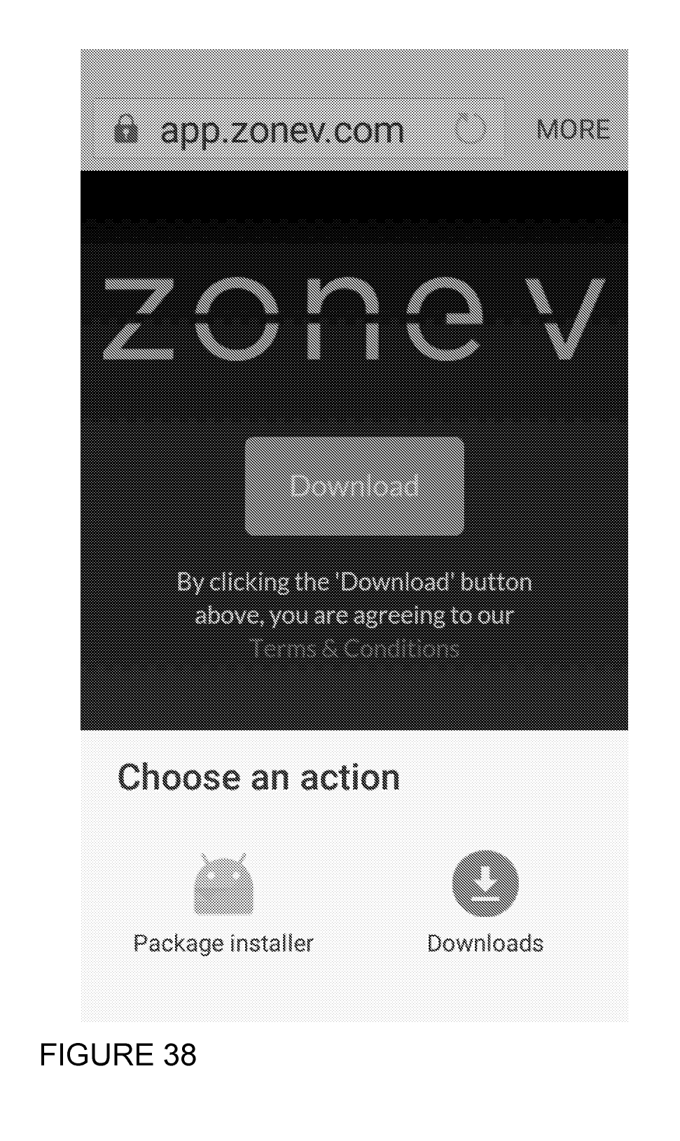

FIG. 38 shows a screenshot with a pop up that is presented to the end-user once the download of the Zone V software has been completed with the ability to select ‘Package Installer’.

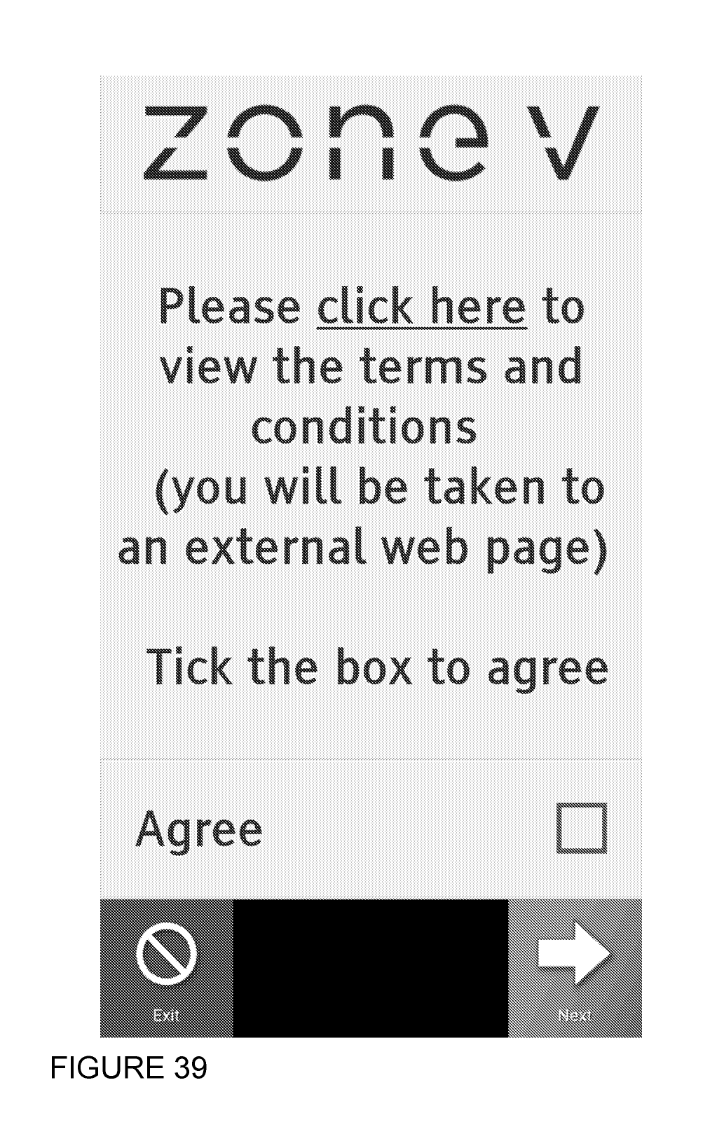

FIG. 39 shows a screenshot of the Zone V app displaying terms and conditions after the package install has finished.

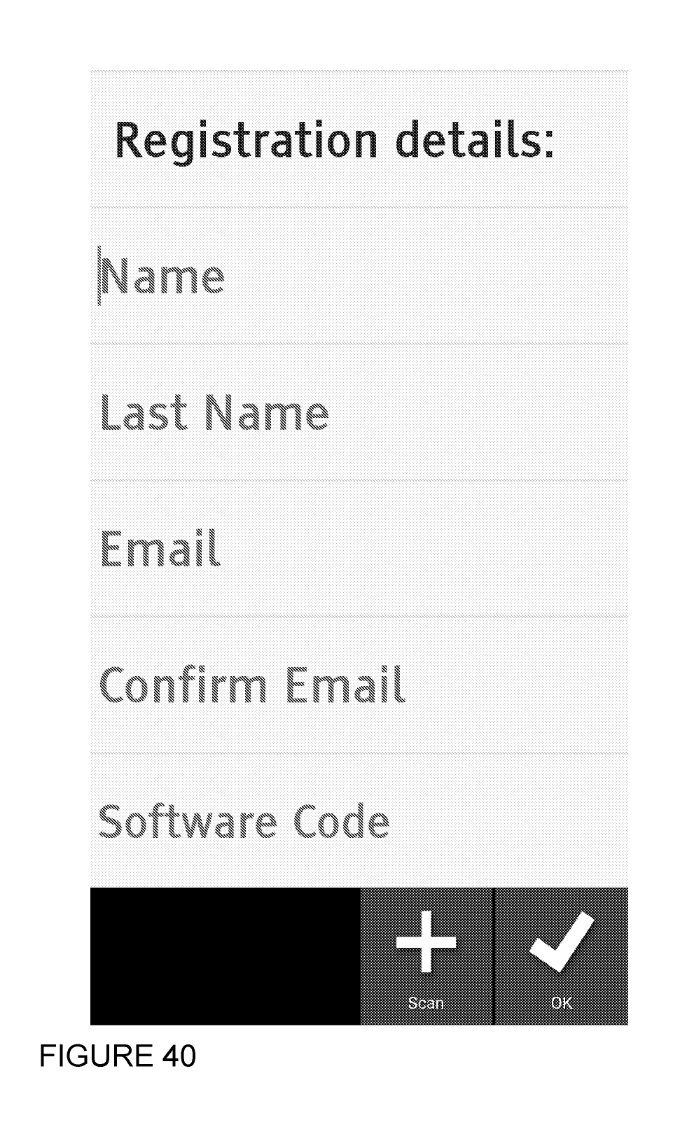

FIG. 40 shows a screenshot of the Zone V app displaying a registration page.

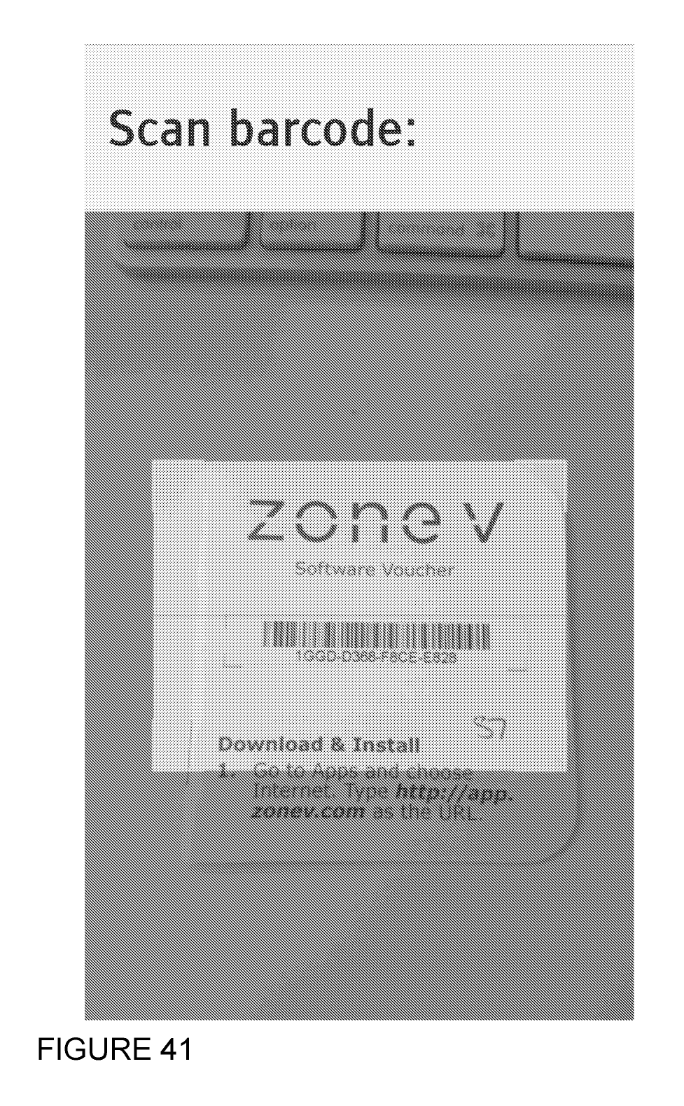

FIG. 41 shows a screenshot of a portable electronic device scanning a barcode that is located on an installation guide, for software code entry.

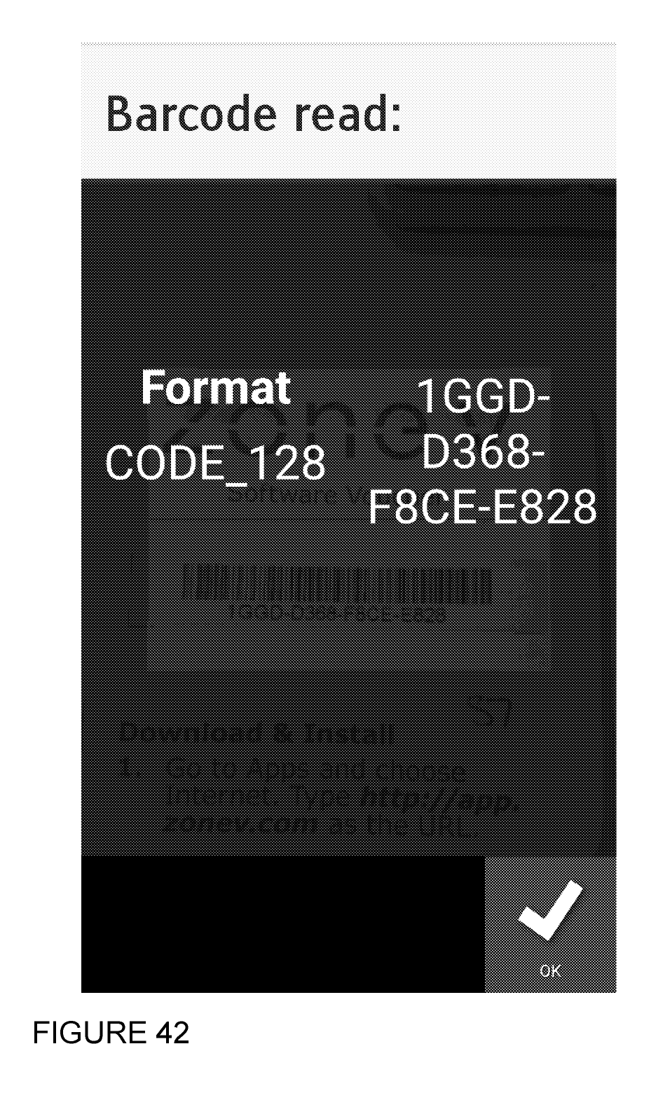

FIG. 42 shows a screenshot of a portable electronic device confirming that the barcode was read.

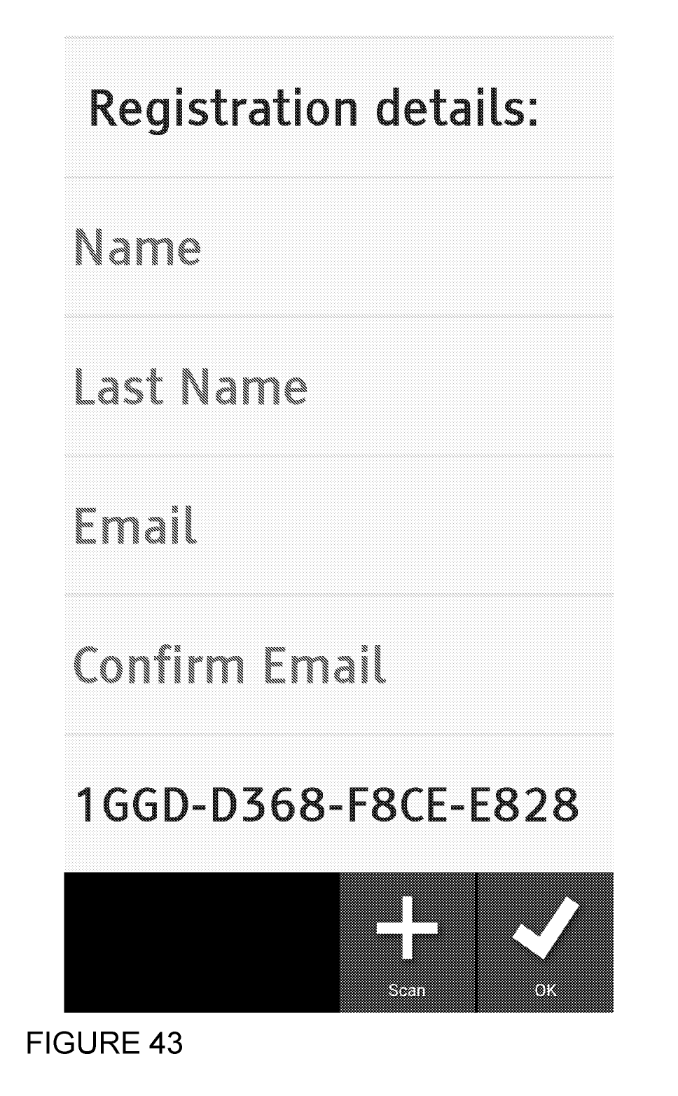

FIG. 43 shows a screenshot displaying the code, corresponding to the previously read barcode, automatically entered onto a registration page of the Zone V app.

### Remote Service

A remote service is also be provided for Zone V user accounts that would give 3^{rd} party users the ability to view and/or edit specified data from a Zone V user's account. Only invited users can have ability to access the data. Hence, strong privacy protection is required.

A web portal may be provided as responsive website. The web portal is wrapped to a native Android, iOS or equivalent app such that the portal may be used on desktop, or any iOS or Android device.

The remote service or web portal provides access to a remotely control Zone V app for specified users who granted the editing permissions to 3rd party users (for example friends and/or family members) who may then use the remove services to access the device, read, edit or delete data from the device and Zone V user accounts.

Different interfaces for different access levels are provided. As an example, an owner, usually a sight impaired person, may need a more visual friendly interface and its interface includes the following features, such as, but not limited to:
ability to select either black on white or white on back colour scheme;
higher zoom in responsive design—need bigger elements, easier to read and/or navigate through.

The interface for a viewer or admin, includes for example:
the ability to select either black on white or white on back colour scheme;
a regular responsive design.

Account initialization: a new remote service account can be created during an end-user's default sign up to Zone V app. The main user of the Zone V app is the default owner of the account on the remote web-portal. Each user of the Zone V is able to sign in to Zone V app via an email account or any other equivalent means. During the sign up to Zone V process, a user is given an option to create their remote service account and select data that they want to sync with this account. If a user uses this option, they are taken out to the remote service app/web browser where they are requested to register.

Additionally a user may be requested to provide access permissions to the Zone V app for their email account for the following data:
user's basic details—name, email;
contacts;
calendar events;
images—picasa photos.

The owner is therefore requested to authorize the email account access permissions for the Zone V app during their first login to the remote system.

An end-user also needs to select what part of data they want to sync with the remote service. Only these data can be shared and available for read and/or write in remote account. These may all be optional, but should be all pre-selected by default, for example:
Contacts;
Calendar events;
Bookmarks;
Photos;
ICE;
Location;
Device Settings.
Profile Settings.

User invitation: an invitation for new users to remote account is sent via web portal. This feature is available to the users with admin or owner permissions only. These users are able to add new users and/or send invites and remove existing users.

Different levels of end-user's access permissions are given, for example: owner, admin and/or viewer. Owner or admin end-users are able to invite new users via app or web-portal.

Account permissions select what permissions a user may be granted:
Admin;
Viewer—the following permissions may be setup:
   Contacts—read/write permission;
   Calendar—read/write permission;
   Bookmarks—read/write permission;
   Photos—read/write permission;
   Settings—read/write permission;
   Location—read permission only.

Invitation sent via email is valid for limited period only. Owner and user who sent the invite (if different from the owner) are notified via email about the acceptance/decline of the invite.

An API allows the Zone V app to interact with the remote service portal/account. The remote server API has the following features:
create new user account/remote service access during Zone V user sign up;
send device summary—model & firmware during sign up. This is saved in a remote database under the specific end-user account;
admins—pull list of admins/viewers of the app along with their read/write permissions;
edit admins/viewers. This provides an owner with the ability to manage users via phone app;
send ICE data—contact info, health info, emergency contacts, SOS settings, special instructions;
send device location—GPS coordinates;
sync albums/photos;
access & edit device setting;
synchronize storage settings with device.

The Zone V app include therefore have the following additional features:
create new user account during sign up;
send device info—model & firmware during sign up;
register devices in remote service for further push notifications;
handle different types of push notifications with further request of updated data from the server;
support big data (images/videos) transferring to/from the server (resuming in case of bad connection);
provide all necessary data about device and allow to change this data;
support secure connection with the server;
have session support;
users management (invite, delete);
sharing restrictions (only images/videos, only contacts and so on).

### Concepts

This section summarises the key high level concepts A-L described above; an implementation of the invention may include one or more high-level concepts or any combination of any of these concepts and related features.

A. Case for a smartphone, the case including a loop, or handle or other form of grip at one end that extends from the body of the smartphone.
Case is sized and shaped to assist elderly or visually impaired users
Grip is a loop shaped grip.
Grip extends from the bottom end or base of the smartphone or tablet.
Case includes a body that covers some of the back and sides of the smartphone.
Grip slides onto the sides of the smartphone.
Rest of the case also slides onto the sides of the smartphone
Grip is secured to the rest of the case with a mechanical fastener.
Grip is an optional accessory that slides onto the sides of the smartphone.
   B. Case for a smartphone, the case including a user-replaceable extension unit that extends from the body of the smartphone or tablet and provides additional or modified functionality for the smartphone.
Case slides onto the smartphone.
Extension unit provides one sort of additional or modified functionality and is replaceable with a different extension unit which provides a different sort of additional or modified functionality.
Extension unit houses one or more user-replaceable modules, which each provide one or more sorts of additional or modified functionality
Extension unit physically mounts on the smartphone and electrically engages with a port or socket in the smartphone for data input and/or output.
Extension unit includes an acoustic re-direction chamber, which aligns at one end with the speaker in the smartphone, and re-directs the sounds from that speaker.
Re-direction is in the frontal direction of the smartphone.
Case provides feedback to the end-user such as tactile feedback or vibration feedback.
Tactile feedback includes tactile markers, which facilitates the end-user navigation through the different features of the smartphone.
Tactile markers provide additional impact protection for the smartphone
Case extension unit includes a keyboard.
Case extension unit includes a 0-9 numeric keypad.
Case extension unit includes a braille button, keypad or soft keys.
Case extension unit includes one or more physical buttons, keys or soft keys, which are programmable to call pre-defined numbers.
Case extension unit includes a physical button, key or soft key, which is programmable to call an emergency number.
Case extension unit includes a medical device.
Case extension unit includes a heart rate monitor.
Case extension unit includes a blood pressure monitor.
Case extension unit includes an alarm button.
Case extension unit includes a location tag.
Case extension unit includes a reading light.
Case extension unit includes a door entry RFID.
Case extension unit includes an area that can be written on to for note keeping.
Case extension unit includes a bar code scanner.
Case extension unit includes a touch pad.
Case extension unit includes a movement sensor programmed to send an alarm signal if a fall is detected.
Case extension unit includes a hearing aid.
Case extension unit includes a mirror.
Case extension includes a camera lens.
Case extension includes an haptic actuator.
Case extension includes a speaker.
Case extension includes a extra battery.
Case extension includes a wireless charging dock.
Case extension includes a stand for video conferencing.
Case extension includes a Wi-Fi hotspot.
Case extension includes a car key entry.
Case extension includes a remote control.
Case extension includes a laser distance measurement device.
Case extension unit includes a light or alarm that is activated when the user activates a ‘find my smartphone’ function
Extension unit extends from the bottom of the smartphone or tablet and increases the length of the smartphone or tablet.
Extension unit extends from the side of the smartphone or tablet that includes a data socket with which the extension unit operatively connects.
   C. Case for a smartphone, the case including (i) an opening that lies over and exposes a USB socket in the smartphone and (ii) a magnetic or metal element located adjacent to that opening to guide in a USB plug into the USB socket, that plug having an element that is magnetically attracted to the element located near the opening.
Socket is a standard micro-USB socket.
Socket is a standard USB C socket.
Socket is a standard USB socket.
Case and USB plug are configured such that it is not possible to connect the USB plug to the power socket the wrong way.
   D. Smartphone system including a smartphone and a case for that smartphone, the smartphone including a full function mode and a simplified mode, and in which the simplified mode gives access to or enables control of one or more functions that are associated with hardware in the case.
The hardware executes or implements one or more of the functions
Function is programming speed dial keys or buttons in the case and the hardware is then those keys or buttons.
Function is a magnifying viewer and the hardware is a magnifying or macro lens in the case.
Extension unit related features of Concept B apply here
Simplified mode is executed using a software application that runs on the smartphone
The software application provides access to functions associated with or enabled by the case.
   E. Smartphone system including a smartphone and a case for that smartphone, the case including a lens that can be moved into position over a camera lens integrated into the smartphone.
The lens magnifies images produced by the integrated camera lens using an optical or digital zoom.
The smartphone runs software that enables the magnified image to be shown on the smartphone screen in different visual modes to aid readability.
One visual mode generates a high contrast black and white image.
One visual mode inverts black and white.
The lens is one of the following: a magnifying lens, a wide-angle lens, a fisheye lens or a macro lens.
The software that enables the magnified image to be shown on the smartphone screen in different visual modes is a simplified environment generated by a downloadable software application which can be run instead of the factory provisioned environment
The simplified environment is an environment to which new apps from an app store cannot be added
The simplified environment is a complete environment that provides the following core functions: alert, clock, calendar, location, contact, messages, call, video call, camera, gallery, music player, internet browser, email, setup, web based contact loading services, remote wipe and delete service, magnifier, light detector, voice services, application list, emergency contact, notes, torch, keypad, lock screen, boot screen, power off screen, home button, haptic integration, app zoom.
   F. Smartphone that is operable to display all menu items on screen in one of several different visual modes or profiles to aid readability.
One visual mode generates a high contrast black and white image.
One visual mode inverts black and white.
Different visual modes generate different font sizes for one or more menu items.
Different visual modes generate different font sizes for one or more web sites that support dynamic font re-sizing.
Different visual modes generate different font sizes for one or more apps that support dynamic font re-sizing.
The apps are selected from a menu list of all apps for which dynamic font re-sizing is available.
The software that enables the display of all menu items on screen in one of several different visual modes or profiles is a simplified environment generated by a downloadable software application which can be run instead of the factory provisioned environment
The simplified environment is an environment to which new apps from an app store cannot be added.
The simplified environment is a complete environment that provides the following core functions: alert, clock, calendar, location, contact, messages, call, video call, camera, gallery, music player, internet browser, email, setup, web based contact loading services, remote wipe and delete service, magnifier, light detector, voice services, application list, emergency contact, notes, torch, keypad, lock screen, boot screen, power off screen, home button, haptic integration, app zoom.
The software runs using Samsung Knox or a functionally equivalent feature or system in the smartphone factory installed software.
   G. Smartphone in which the graphical user interface includes menu items at the top level of the menu hierarchy which are arranged as between four and seven rows extending across the width of the display, each row being labelled with the name and/or an icon for a specific function, and each row being vertically scrollable with a touch swipe up or down, to reveal other menu rows.
The vertical scrollable rows occupy at least half of the available screen.
Single row of fixed menu items sits underneath the vertically scrollable rows.
The fixed menu items are user definable.
The software that generates the graphical user interface is a simplified environment generated by a downloadable software application which can be run instead of the factory provisioned environment
The simplified environment is an environment to which new apps from an app store cannot be added
The simplified environment is a complete environment that provides the following core functions: alert, clock, calendar, location, contact, messages, call, video call, camera, gallery, music player, internet browser, email, setup, web based contact loading services, remote wipe and delete service, magnifier, light detector, voice services, application list, emergency contact, notes, torch, keypad, lock screen, boot screen, power off screen, home button, haptic integration, app zoom.
The software runs using Samsung Knox or a functionally equivalent feature or system in the smartphone factory installed software.
   H. Smartphone in which the graphical user interface (GUI) includes a menu item that, when selected, causes the font size to be increased for one or more web sites that support dynamic font re-sizing and also all text on the home screen of the GUI or the main menu screen of the GUI which lists the apps available from this GUI.
Different visual modes generate different font sizes for one or more apps that support dynamic font re-sizing.
Main menu items include one or more of the following: messages, contacts, phone, settings, calendar, clock, applications, arrange apps, emergency contact, any pre-selected app, email, internet, GPS, video tutorial, exit.
The software that generates the graphical user interface is a simplified environment generated by a downloadable software application, which can be run instead of the factory-provisioned environment.
The simplified environment is an environment to which new apps from an app store cannot be added.
The simplified environment is a complete environment that provides the following core functions: alert, clock, calendar, location, contact, messages, call, video call, camera, gallery, music player, internet browser, email, setup, web based contact loading services, remote wipe and delete service, magnifier, light detector, voice services, application list, emergency contact, notes, torch, keypad, lock screen, boot screen, power off screen, home button, haptic integration, app zoom.
The software runs using Samsung Knox or a functionally equivalent feature or system in the smartphone factory installed software.
   I. Smartphone in which the graphical user interface (GUI) includes a menu item that, when selected, causes the font size to be increased for one or more apps that support dynamic font re-sizing and also all text on the home screen of the GUI or the main menu screen of the GUI which lists the apps available from this GUI.
Different visual modes generate different font sizes for one or more web sites that support dynamic font re-sizing.
Main menu items include one or more of the following: messages, contacts, phone, settings, calendar, clock, applications, arrange apps, emergency contact, any pre-selected app, email, internet, GPS, video tutorial, exit.
The software that generates the graphical user interface is a simplified environment generated by a downloadable software application which can be run instead of the factory provisioned environment
The simplified environment is an environment to which new apps from an app store cannot be added
The simplified environment is a complete environment that provides the following core functions: alert, clock, calendar, location, contact, messages, call, video call, camera, gallery, music player, internet browser, email, setup, web based contact loading services, remote wipe and delete service, magnifier, light detector, voice services, application list, emergency contact, notes, torch, keypad, lock screen, boot screen, power off screen, home button, haptic integration, app zoom.
The software runs using Samsung Knox or a functionally equivalent feature or system in the smartphone factory installed software.
   J. Smartphone in which the graphical user interface includes a menu item that, when selected, causes voice feedback to be activated, that menu item being listed as one of several available modes or profiles which each aid usability for elderly or vision impaired users.
The software that generates the graphical user interface is a simplified environment generated by a downloadable software application which can be run instead of the factory provisioned environment
The simplified environment is an environment to which new apps from an app store cannot be added
The simplified environment is a complete environment that provides the following core functions: alert, clock, calendar, location, contact, messages, call, video call, camera, gallery, music player, internet browser, email, setup, web based contact loading services, remote wipe and delete service, magnifier, light detector, voice services, application list, emergency contact, notes, torch, keypad, lock screen, boot screen, power off screen, home button, haptic integration, app zoom.
The software runs using Samsung Knox or a functionally equivalent feature or system in the smartphone factory installed software.
   K. Software application executable on a smartphone, which enables the smartphone to automatically switch from a factory installed graphical user interface (GUI) to another simplified graphical user interface (simplified GUI) that displays all text in an enlarged font size and changes the appearance of menu items to black and white increase legibility.
The software application is automatically executed when the portable electronic device is switched on or unlocked.
The graphical user interface displays all menu items on screen in one of several different visual modes or profiles to aid readability.
The menu items are on the home screen of the simplified GUI or the main menu screen of the simplified GUI which lists the apps available from this GUI.
The software that generates the graphical user interface is a simplified environment generated by a downloadable software application which can be run instead of the factory provisioned environment.
The simplified environment is an environment to which new apps from an app store cannot be added.
The simplified environment is a complete environment that provides the following core functions: alert, clock, calendar, location, contact, messages, call, video call, camera, gallery, music player, internet browser, email, setup, web based contact loading services, remote wipe and delete service, magnifier, light detector, voice services, application list, emergency contact, notes, torch, keypad, lock screen, boot screen, power off screen, home button, haptic integration, app zoom.
The software runs using Samsung Knox or a functionally equivalent feature or system in the smartphone factory installed software.
One visual mode generates a high contrast black and white image
One visual mode inverts black and white.
Different visual modes generate different font sizes for one or more menu items.
Different visual modes generate different font sizes for one or more web sites that support dynamic font re-sizing.
Different visual modes generate different font sizes for one or more apps that support dynamic font re-sizing.
The apps are selected from a menu list of all apps for which dynamic font re-sizing is available.
The graphical user interface includes menu items at the top level of the menu hierarchy which are arranged as between four and seven rows extending across the width of the display, each row being labelled with the name and/or an icon for a specific function, and each row being vertically scrollable to reveal other menu rows.
The menu item sitting at the top of the vertical scrollable rows includes a set of pre-defined contact numbers and their associated profile icon.
Menu items at the top level include one or more of the following: messages, contacts, phone, settings, calendar, clock, applications, arrange apps, emergency info, any pre-selected app, email, internet, GPS, video tutorial, exit.
The vertical scrollable rows occupy at least half of the available screen.
Single row of fixed menu items sits underneath the vertically scrollable rows.
The fixed menu items are user definable.
Different visual modes generate vibration feedback that confirms when an icon or key has been selected.
Different visual modes generate a keypad with different font sizes.
The graphical user interface includes a menu item that, when selected, causes voice feedback to be activated.
The graphical user interface includes a menu item that, when selected, causes voice command to be activated.
   L. Portable electronic device or the case includes an NFC chip which is operable to interact with a NFC device to launch an internet browser when brought in proximity to the NFC device, the browser enabling the download and installation of software on the portable electronic device.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. An accessory system for a smartphone or tablet or other wireless device of specific utility for visually impaired or elderly users, the system comprising:
(a) a case that is adapted to slide or clip or otherwise attach to the device, the case enabling one or more features or functions of the device to be enhanced, altered, replaced or varied to include features or functions of specific utility for visually impaired or elderly users; and
(b) a software application that when installed on the device automatically enhances, alters, replaces or varies pre-installed software on the device to include features or functions of specific utility for visually impaired or elderly users.

2. The accessory system of claim 1 in which the case comes in two parts, namely (a) a base that the user slides or clips or otherwise attaches onto the device, and (b) an accessory or extension module that the user also slides or clips or otherwise attaches onto the device and that provide features or functions that are specific to the needs of the visually impaired or elderly.

3. (canceled)

4. The accessory system of claim 1 in which the software application is downloaded and installed on the device by the device or the case using an NFC chip to interact with a NFC device to launch an Internet browser, the browser enabling the download and installation of the software application on the device.

5. The accessory system of claim 1 which is configured or designed to attach to a device which is a mass-market device that is not specifically designed for visually impaired or elderly users.

6. The accessory system of claim 1 in which the software application generates a graphical user interface that is a simplified mode or environment that (i) replaces or varies the factory provisioned environment for the device and that (ii) provides features or functions that are specific to the needs of the visually impaired or elderly, in which the simplified mode or environment gives access to or enables control of one or more functions or features provided by the case.

7. The accessory system of claim 6 in which the software application is downloadable to the device and runs using Samsung Knox or a functionally equivalent feature or system in the device's factory installed software.

8. The accessory system of claim 6 in which the simplified environment is an environment to which new apps from an app store cannot be added.

9. The accessory system of claim 6 in which the simplified environment is a complete environment that provides the following core functions: alert, clock, calendar, location, contact, messages, call, video call, camera, gallery, music player, internet browser, email, setup, web based contact loading services, remote wipe and delete service, magnifier, light detector, voice services, application list, emergency contact, notes, torch, keypad, lock screen, boot screen, power off screen, home button, haptic integration, app zoom, “find my device”.

10-62. (canceled)

63. The accessory system of claim 1 in which the software application enables the device to provide a full function mode and a simplified mode, and in which the simplified mode gives access to or enables control of one or more functions that are associated with hardware in the case or functions or features provided by the case.

64-75. (canceled)

76. The accessory system of claim 1 in which the software application enables or modifies the device so that it is operable to display all menu items on screen in one of several different visual modes or profiles that each aid or assist readability.

77. The accessory system of claim 76 in which one visual mode generates a high contrast black and white image, or alternative colors to give optimal contrast and clarity.

78. The accessory system of claim 76 in which one visual mode inverts black and white.

79. The accessory system of claim 76 in which different visual modes generate different font sizes for one or more menu items.

80. The accessory system of claim 76 in which different visual modes generate different font sizes for one or more web sites that support dynamic font re-sizing.

81. The accessory system of claim 76 in which different visual modes generate different font sizes for one or more apps that support dynamic font re-sizing.

82. The accessory system of claim 81 in which the apps are selected from a menu list of all apps for which dynamic font re-sizing is available.

83. The accessory system of claim 1 in which the software application provides a graphical user interface that supplements or replaces the factory-installed graphical user interface and includes menu items at the top level of the menu hierarchy which are arranged as between four and seven rows extending across the width of the display, each row being labelled with the name and/or an icon for a specific function, and each row being vertically scrollable with a touch swipe up or down, to reveal other menu rows.

84. The accessory system of claim 83 in which the vertical scrollable rows occupy at least half of the available screen.

85. The accessory system of claim 83 in which single row of fixed menu items sits underneath the vertically scrollable rows.

86. The accessory system of claim 85 in which the fixed menu items are user definable.

87. The accessory system of claim 1 in which the software application provides a graphical user interface (GUI) that includes a menu item that, when selected, causes the font size to be increased for one or more web sites that support dynamic font re-sizing and also all text on the home screen of the GUI or the main menu screen of the GUI which lists the apps available from this GUI.

88. (canceled)

89. The accessory system of claim 87 in which main menu items include one or more of the following: messages, contacts, phone, settings, calendar, clock, applications, arrange apps, emergency contact, any pre-selected app, email, internet, GPS, video tutorial, exit, “find my device”.

90-92. (canceled)

93. The accessory system of claim 1 in which the software application provides a graphical user interface (GUI) that provides a menu item that, when selected, causes voice feedback to be activated, that menu item being listed as one of several available modes or profiles which each aid usability for elderly or vision impaired users.

94. The accessory system of claim 1 in which the software application enables the device to automatically switch from a factory installed graphical user interface (GUI) to another simplified graphical user interface (simplified GUI) that displays all text in an enlarged font size and changes the appearance of menu items to black and white or alternative colors to increase legibility.

95. The accessory system of claim 1 in which the software application is automatically executed when the device is switched on or unlocked.

96. (canceled)

97. The accessory system of claim 94 in which the menu items are on the home screen of the simplified GUI or the main menu screen of the simplified GUI which lists the apps available from this GUI.

98-102. (canceled)

103. The accessory system of claim 76 in which the different visual modes generate vibration feedback that confirms when an icon or key has been selected.

104. The accessory system of claim 76 in which the different visual modes generate a keypad with different font sizes.

105-112. (canceled)

113. The accessory system of claim 1 in which the software application provides a graphical user interface (GUI) that provides a menu item that, when selected, causes voice command to be activated, that menu item being listed as one of several available modes or profiles which each aid usability for elderly or vision impaired users.
